(19) United States
(12) Patent Application Publication
(10) Pub. No.: US 2003/0054326 A1
(43) Pub. Date: Mar. 20, 2003

(54) Toilet training aide and behavior modification reward system

(76) Inventor: Tammie Marie Aaron-Barrada, Ruffs Dale, PA (US)

Correspondence Address: NILS H. LJUNGMAN, NILS H. LJUNGMAN & ASSOCIATES, P.O. BOX 130, GREENSBURG, PA, 15601, US

(21) Appl. No.: 10/219,381

(22) Filed: Aug. 14, 2002

Related U.S. Application Data
(60) Provisional application No. 60/312,430, filed on Aug. 15, 2001.

(51) Int. Cl. G09B 19/00

(52) U.S. Cl. 434/236

(57) ABSTRACT

The sticker sets are an improved and portable toilet training aide and behavioral modification teaching and learning tool system. They come in many themes. Each theme allows children creativity and imagination development while reinforcing a positive and rewarding system for toilet training and behavior modification. The sticker sets are colorful pressure sensitive labels which children place onto a preprinted background of various themes. Each individual theme set has a theme background design which is imprinted onto a surface such as, but not limited to, paper and has a variety of approximately thirty colorful theme related designs imprinted onto a surface such as, but not limited to, a pressure sensitive label stock and custom die cut on a second sheet. The child selects a sticker for a successful potty or behavior modification experience and then places it anywhere he or she desires on the preprinted background sheet.

### APPLICATION PRIORITY DATA

This application claims priority under 35 U.S.C. 119(e) from copending U.S. Provisional Patent Application No. 60/312,430, filed on Aug. 15, 2001.

### BACKGROUND OF THE INVENTION

1. Field of the Invention

The present invention relates to a portable toilet training aide for use in training children how to use the toilet. The present invention further relates to a system of behavior modification in which rewards are utilized to positively reinforce a desired behavior. The present invention also relates to a behavior modification system that has two stages for younger and older children.

The present invention further relates to every person who has ever tried to discipline and toilet train a child. Behavioral modification and toilet training are two of the hardest things a care giver will face in their life time. Toilet training and behavioral modification are a lot of hard work and can become extremely frustrating for the adult, as well as the child. All children want and need to hear praise to encourage them in every event in their young lives. This invention helps to motivate a child in a positive manner with a fun-designed reward system. Everybody wins when a child is proud of their accomplishments. Potty stickers and reward stickers are an excellent learning tool and also allow a child to creatively express themselves. Whether the child places the stickers in matching sets, stacks them on top of each other, places them according to size or makes a train with the stickers across the length of the background sheet or actually creates a picture, they are having fun and want more. The children will do their best to play this new game of potty stickers and reward stickers. It should be noted that the words toilet and potty refer to the same object herein. Further, the terms children or toddlers refer to children between approximately one year old to approximately seven years old.

2. Background Information

Toilet training came first for us and then the behavioral modification. Many issues surfaced which complicated toilet training. We needed something portable, consistent, exciting, motivating, uncomplicated, able to build self esteem with a positive reinforcement. Unable to find anything to interest my son and after advice from every source available we still could not encourage him to use the toilet. Then it hit me, I designed a brilliant colorful background sheet of bright shapes which I taped on the back of the bathroom door. When my son sat on the toilet I gave him one sticker, when he urinated I gave him two stickers, when he defecated he got three stickers. Being a new mom I also wanted my son to be perfect. When he placed a sticker upside down I encouraged him to turn it right side up. Disaster. He was too young to comprehend what I was telling him. I then designed a system to encourage and intrigue him, while still holding his attention. Stage one stickers when applied to the background sheet are correct no matter how or where the child places it. Stage two stickers allow the child to create a scene and design a picture. Each sticker set has a matching background to excite a child. Due to short attention spans there are many designs to use at the same time.

Our potty sticker background sheet was taped up on the back of the bathroom door (it could be taped on the inside of a cabinet door or simply placed on a refrigerator with a magnet, or sat on a shelf). Another one was ready to go in an instant when we left the house. For traveling daily an additional unit can be used or the same one can be rolled up, flat or folded for travel. I rolled up my son's set and placed it in my purse when we went out for dinner and on trips. When my husband took our son hiking and on day trips he folded another one into a fanny pack or in his pocket. The day care had another design set and of course there were sets at the grandparents house. We now had complete portability with consistency. He loved all of his stickers.

If potty time was a success, the child got to select which potty sticker they wanted each time. Potty stickers were handed to the child to place where they wanted to. A reward system should be consistent such as one sticker for sitting for toilet training or one sticker for an every day task. Two stickers for urination or a little job around the house. Three stickers for a defecation or a new behavioral modification to be learned. Children have as much fun selecting which sticker they get as they do applying them. There are many different sticker themes which can be used as fun and entertainment, for craft or parties, for use in car travel, and many more ways even after potty training has become a huge success.

Discipline was our next issue. Behavioral modification is a must for any care giver to remain sane. In the time span of our toilet training to present day I lost my beloved husband and dearly loved father of my two toddlers. In this short period of time with too many complications to ever express, I now needed something to correct the behavior of the children. As a single parent I was now more determined to regain control. I now designed the two stages of stickers for behavioral modification learning. Since my daughter was a year younger I needed potty stickers for her in addition to the behavioral modification stickers. My daughter used stage one designs. No matter how or where they place the sticker on the theme related background sheet she was correct. My son being older could now determine how he wanted to design a scene. He used the second stage designs which allowed him to create his own picture.

Let's get back to the basics of teaching and discipline and quit bribing our children with candy and money to get them to do what we want. We have been bribing our children for years in every means we could possibly think of to encourage potty training as early as possible and further still for disciplining their young minds. Children grow up thinking money comes easily. When disposable diapers were invented it became easier to not train our children so early. Now we suffer the consequences of the increasing volume of disposable diapers in landfills. The diapers are not readily biodegradable and have accumulated overwhelmingly due to the busy life-styles of today's working parent, not to mention the expense of disposable diapers. Research shows that in 1957, ninety two percent of children were toilet trained by eighteen months of age. Today, it is less than 25 percent. The age at which toddlers stop needing diapers has been moving upward. We are lucky if most children have accomplished this feat by the time they are three, four or even five years old.

Most concerning is new research proving ailments in our children who prolong toilet training. Pediatricians say they are seeing more children who are withholding urine and stool, have chronic constipation, and have a fear of using the toilet, as well as an increased number of cases of wetting and soiling by older children. This sets the stage for numerous discipline problems that the typical mother years ago did not experience with her children. The long-term effects, especially in the area of toilet training, could be detrimental to the esteem and health of the child.

There is a controversy between pediatrician, T. Berry Brazelton, and syndicated columnist and best-selling author of books for parents, John Rosemond. Rosemond believes it is a “slap to the intelligence of a human being that one would allow baby to continue soiling and wetting himself past age 2.” Brazelton says, “Don't rush your toddler into toilet training or let anyone else tell you it's time. It's got to be his choice.” The diaper manufacturers now make larger and older children modeled disposable diapers to size six as an average now for over thirty five pound young children.

We suggest cloth diapers, which in studies have proven to toilet-train babies up to a year quicker than disposables. Why? The cloth diapers let the child know when he/she is wet. It isn't difficult to see that if your child never felt the wetness, and the disposables were taking care of it, why bother learning? Realistically, the child doesn't have to learn, if it's always being taken care of.

On top of it all, now our kids can't go to the schools we want. I applied for my son to attend a Montessory school. We missed the deadline for another whole year because he was not toilet trained. We also missed our second choice school for the same reason. Many preschool programs, mother's day out programs and various schools will not accept a child that is not toilet trained by the age of two and a half to three years of age. We need something creative to encourage and inspire our children to potty train at an earlier age.

As we all know it takes a little longer with boys than girls for toilet training. My son was 3½ and my daughter was only 18 months old. Every method I found and tried simply failed. Nothing could hold his attention long enough to encourage and inspire him. It was very frustrating for my son as well as myself through this time until I designed potty stickers for him. This invention is directed to a toilet training aide which encourages children in a positive and creative manner. A communication tool without words through stickers.

It is hard enough as adults to keep up with our schedules, let alone to have a child forced to live with our schedules too. It is difficult to expect a child to learn to potty train only when we are at home evenings and on weekends. We confuse them with pull up pants one day at child care and diapers when we go out to dinner, which sends a message that it is okay to potty in our pants, then put them in underwear when we are home and expect them to use the toilet. Potty stickers ended that all for me. I simply kept my son in underwear and took along our potty stickers where ever we went no matter how far from home we were. Being so travel friendly and portable is such a convenience in toilet training. We could be consistent no matter where we went. Now our reward stickers travel with us everywhere during the week in my purse, to school, summer day care providers, on vacations and day trips, to their grandparents' house, and, of course, at home.

If motivated early, a child can potty train at an early age. Positive reinforcement can help form a positive character in a child. This praise also makes the learning experience more fun and rewarding. My 18 month old doesn't say many words yet—I believe she is intelligent—however it is not easy for a parent or care giver to communicate thoroughly with a small child the techniques and reasons for using a potty daily. At the age of 8 months she actually showed interest in sitting on the potty. Being a process that can take a few weeks to accomplish, or generally more like a few months, I had greater success with the potty stickers in a matter of weeks after months of hardships. Now using the behavioral modification learning aides we are organizing, cleaning, folding clothes, setting the table, emptying the dishwasher, picking up toys, brushing teeth, and the list goes on.

Other products, such as sticker activity and coloring books as described in U.S. Pat. No. 5,269,691 to Waldman, are targeted for older children and have complicated systems and instructions that toddlers do not understand with many pages of elements that distract toddlers from the basic issue of toilet training. The toy sticker collection album and collectible stickers as in U.S. Pat. No. 4,714,275 to Engel uses printing techniques and filters to see images. Potty stickers essentially do not need instructions.

Other toilet training patents are related to boys only, such as U.S. Pat. No. 5,285,540 to Putz, which patent describes sheets with printed patterns that dissolve when contacted with urine, or U.S. Pat. No. 4,744,113 to Kogut of an invisible image that appears when contacted with urine. A little girl that would be sitting would not see this happening. These systems only promote half of the bodily function in toilet training and are designed more for little boys target aiming accuracy, such as in U.S. Pat. No. D428,976 to Mattera and U.S. Pat. No. 6,183,850 to Laurer.

Still other toilet training systems that are not very portable use charts or game board type instruments, such as U.S. Pat. No. 6,203,327 to Ottrando, or wall mounted devices that list days of the week, such as in U.S. Pat. No. D330,225 to Cohen. U.S. Pat No. 6,203,327 to Ottrando describes board or toilet seat mounted devices and systems that won't connect to all the variety of shapes and sizes of toilet seats of today. Systems such as in U.S. Pat. No. 5,829,073 to Lee use three dimensional puffy static cling vinyl appliques on a toilet seat lid, which is not portable at all and the vinyl does not stick for days. Further, the repetition of all the toilet training aides in U.S. Pat. No. 5,829,073 causes the child, who generally has a short attention span, to lose interest quickly. Other toilet training aides include chairs shaped as vehicles, animals, or other novelty designs, entertainment center potty chairs, and intelligent chairs that play music for different child activities, such as in U.S. Pat. No. 5,978,976 to Chai. All of these potty training methods and tools are not easily portable.

Some toilet training kits are comprise of toy animals that urinate, such as in U.S. Pat. No. 6,234,862 to Wittenberg, or have toy toilets with toy dolls that urinate, such as in U.S. Pat. No. 5,509,808 to Bell. While these systems may educate a child, they do not promote a portable toilet training system.

Behavior modification learning aides also need to be portable with today's busy lifestyles. U.S. Pat. No. 2,414,614 to Shurick for a children's behavior indicator is one example of the many board-stylized systems which do not travel well or have many loose parts that can be lost, such as in U.S. Pat. No. 5,577,915 to Feldman. Many systems do not hold children's attention as colorful artwork does. Some devices use a monetary system for rewards such as U.S. Pat. No. 5,573,404 to Stawski or U.S. Pat. No. 5,639,242 to Wilson. These devices are too complicated for young children to comprehend who do not read or write.

### OBJECT OF THE INVENTION

One possible object of the present invention is to provide a device and method to help children learn and master various tasks, such as toilet training and household chores, that overcomes some of the disadvantages of the above prior art.

Another possible object of the present invention is to provide a portable device and method.

While the foregoing described prior art devices have to some extent improved their respective arts and have in some instances enjoyed commercial success, there remains nonetheless a continuing need in the art for improved, more interesting encouragement for our children today for successful, portable and creative toilet training and behavioral modification learning aides.

Other objects and advantages of the present invention will become apparent from the following descriptions, taken in conjunction with the accompanying drawings, wherein, by way of illustration and example, an embodiment of the present invention is disclosed.

### SUMMARY OF THE INVENTION

As the story goes, parents need a toilet training aide and a discipline tool for behavioral modification learning that molds easily to their lives and schedules while still being consistent in the endeavors of toilet training and discipline. It was even harder for me because we went out to dinner a lot, every weekend we went somewhere, once a month we went on a local trip within a few states, four to five times a year we would travel across the country visiting relatives, and two to three times a year traveling internationally. If you throw in day care it was an absolute mess trying to keep a consistent potty training system going with my son and daughter, then later the behavioral modification learning. I needed something portable, interesting, exciting for them both, light and easy to manage. I wanted also to educate them and the first potty sticker set I invented were colorful shapes and backgrounds. It worked, so then I created many more to keep it exciting and new. We have his and her backgrounds with stickers handy at all times. They now compete to create a picture. It is a huge success and now my 18 month old daughter enjoys her doll and flower potty stickers as well. So I figured parents everywhere and child care systems could use something so portable, educational, and inspiring to encourage children wherever they may go to use this improved toilet training aide and reward system.

To further explain, the background sheet and sticker set can be portable and relatively easily stored in a bag, purse, fanny pack, back pack, etc. This portability can permit the adult care giver to implement the reward system at virtually any location outside the home, such as a day care center, a restaurant, homes of friends or family, vacation destinations, etc. This ability to implement the reward system at home and away establishes consistency and improves learning.

Everyone in the family feels the joy and happiness when a child is proud of his or her own successes. Praise is just sometimes not enough with our over stimulating world of today. By having a variety of choices, there is bound to be something for every child to enjoy in the potty sticker toilet training aides and behavioral modification learning aides.

The simplest arrangement of labels made by an eighteen month old will melt your heart anyway. Even if the stickers are overlapping on top of each other, the child is organizing in his or her mind and should be encouraged to continue as they want. For example, a three year old may actually create a picture. Let the child place the stickers as they choose, allowing and encouraging them with the freedom of choice, creating a sense of pride in having made their own decision. This also helps build decision-making skills, self-esteem, and independence. Through the various themes, such as letters and numbers, endangered animals, farm items, flowers, and shapes, a child can also learn the names of various items, colors, how to count, and say the alphabet.

Allow the child to select and record his or her own success by selecting the sticker of their choice for a successful event, then placing the sticker or stickers on the theme background anywhere of their choosing. Allow creativity through their own choice. Designing their own picture allows children to visualize progress toward an end goal.

Further, in one possible embodiment of the present invention, a background theme sheet with no stickers on it is presented to a child. The child is instructed that upon completion of a task, such as use of the toilet or a household chore, the child will be rewarded with a sticker or stickers, depending on the task. The child is then permitted to place the sticker or stickers on the background theme sheet to create a scene. In this manner, the child is encouraged to continue to learn and master various tasks in order to obtain additional stickers to place on the background sheet. In addition, the child further develop skills such as creativity and independence since the child executes control in where the sticker or stickers are placed on the sheet and how they are oriented.

To further explain, in at least one possible embodiment of the present invention, the stickers and background sheets can be designed so that they are somewhat age specific. Very young children, such as those under two or three years of age, may have difficulty placing stickers in a particular place or in a particular orientation on the background sheet. They may not understand the concept of placing an image “right side up,” or oriented properly with the scene on the background sheet. Therefore, the sticker and background sheets can be grouped into stage one, which are designed for very young children, or stage two, which are designed for older children. In stage one, the background sheets can have scenes such as an ocean or the sky. The corresponding sticker set may contain, for example, fish or butterflies. Since fish and butterflies move anywhere and in any direction in the ocean or sky, very young children may place the stickers in any manner on the background sheet. There is essentially no concern then for orienting the images correctly with the background sheet. In contrast, stage two stickers and background sheets for older children encourage correct orientation of the images and positioning to create a desired scene or picture. For example, a stage two background sheet might show an ocean surface. The corresponding sticker set may have images of boats or other water craft. Since a boat's bottom in reality must face or sit on the water's surface, a correct orientation of the boat with respect to the water surface depicted on the background sheet is encouraged. The older child can place the images selectively to create a specific scene where the images are oriented correctly.

In at least one other possible embodiment of the present invention, the child is given different amount or numbers of stickers for each individual task. For completion of very simple or basic tasks, the child could be given one sticker. For completion of more complicated tasks, the child could be given at least two or more stickers. For example, in toilet training, the child could receive one sticker for the simple act of sitting on the potty. If the child urinates successfully in the toilet, which is more difficult than just sitting on the toilet, the child may receive two stickers as an increased reward. If the child successfully defecates, which is often more difficult than urination, the child may receive three stickers as the maximum reward. In this manner, the child will receive a reward that increases as the level of difficulty of the task increases. With an increased reward, the child will essentially have an increased desire to complete a more difficult task. This method would also apply to teaching household tasks and chores which range from the simple, such as brushing one's teeth, to the more complex, such as helping clean dishes after a meal. The preceding is for exemplary purposes only, and it is to be understood that the care giver administering the system may determine or choose any number of stickers to be given upon completion of a particular task by the child.

Potty training can be a very emotional and sometimes frustrating time for children. A children's self-esteem is raised when they take pride in something they have done. They also gain a sense of responsibility for what they have done. They will love the colorful stickers and behavior modification which flows easily wherever this system is used.

Stickers in general have always amused children, but the toilet training aide potential of educating and rewarding in this manner has yet to be acknowledged. The present invention teaches a toilet training aide which encourages children to use the toilet or potty.

Potty stickers and behavioral modification reward stickers can be produced in various shapes, sizes, colors and themes. In stage one of each set no matter how or where a child will place a sticker onto the supplied background theme sheet they will be correct. There will be no wrong way to apply a sticker through careful designing. Stage two of each of the sets is designed for older or advanced children who can now create a scene and develop a picture with stickers. Samples of these themes include fish in a fish tank, candy in a candy jar, glow bugs in the grass and sky, mermaids under water, sea horses in the sea, sea shells on the beach, kites in the sky, airplanes in the sky, butterflies in the sky, three dimensional shapes, tools in a tool box, jewelry in a jewelry box, toys in a toy box, hummingbirds on flowers, flower buds on greenery in a vase, worms underground, ants in an ant farm, sporting equipment on the fields, boats on the ocean, doll house with furniture, doll chair with dolls, jungle land with dinosaur stickers, construction site with bull dozers, trucks and constructions sign stickers, farm land with house and barn with farm animal stickers, dolls with jewelry stickers, toy box shelf with all types of dolls and toy stickers, fire house with fire truck and hydrants and hoses stickers, wild animal stickers, forest animal stickers, endangered animals, zoo animals, dinosaurs, reptiles, bugs and insects, unicorns, fairies, mystical creatures, teddy bears, teddy bears, circus, merry-go-round, cowboy & western, birds, cat, dog, field of flowers, fruit, butterflies, children's recreation art, pets, children at play, old west, old fashioned animals, old fashioned automobiles, old fashioned cat, old fashioned cherubs, paper dolls, clowns, shapes, designs, letters, words, math, and numbers, etc.

To further explain, the background sheet and sticker sets of the training kits can be designed in a virtually limitless number of themes. This permits an adult care giver a wide variety of kits to utilize. Since many children, especially very young children, have extremely short attention spans, in one embodiment of the present invention, it may be preferable to utilize kits of different themes at the same time in the training process to avoid boredom of the child through repetition of the same kit.

The stickers can contain an image on one side and an adhesive layer on the other side. In one embodiment of the present invention, the stickers can be essentially permanently affixed to the background sheet to create a scene. The child can therefore build upon the overall picture by adding stickers to the number of stickers already present from previous successful completions of tasks. Further, the stickers also remind the child of the success achieved during the training and encourage the child to complete more tasks.

The background theme sheets, in at least embodiment, are sheets that measure eight and a half inches by eleven inches, or the size of a standard letter size sheet. Additional standard paper sizes, such as eight half inches by fourteen inches or eleven inches by seventeen inches could also be used for the background theme sheets. Although these measurements represent preferable sizes for the background theme sheet, it is to be understood that other measurements for the size of the backgrounds theme sheets are possible and fall within the scope of the invention.

The sheets can be full-bleed sheets in that the background design could extend all the way to the edge of the sheet with essentially no border. The sheets can also be designed with a border when desirable.

The sticker sets, in at least one embodiment of the present invention, are stored on storage sheets that measure five inches by eight inches in size. Approximately thirty stickers could be stored on one storage sheet. The measurements of the storage sheet and number of stickers in a sticker set described herein are for purposes of example only, and it should be understood that any number of stickers and storage sheet sizes are possible within the scope of the present invention. The sticker sets could be packaged with a corresponding background theme sheet. The sticker sets could also be packaged individually.

In at least one possible embodiment, the stickers could be chosen from a selection screen on a computer by the care giver or the child. For portable uses, a lap top computer possibly could be used. In one other possible embodiment, the adult care giver could possibly download available designs and background sheets for use from the Internet onto a computer.

While particular embodiments illustrated of the present invention of concepts contained herein, as well as additional themes, have been shown and described, it will be obvious to those skilled in the art that various alterations, changes and modifications may be carried out without departing from the scope of the invention in its broader aspects. The specific embodiments illustrated are given by way of example only and should not be considered as limiting the scope of the invention in accordance with the accompanying claims. Accordingly, the present invention can be practiced other than as specifically described in the claims and descriptions.

The above-discussed embodiments of the present invention will be described further hereinbelow. When the word “invention” is used in this specification, the word “invention” includes “inventions”, that is the plural of “invention”. By stating “invention”, the Applicant does not in any way admit that the present application does not include more than one patentably and non-obviously distinct invention, and maintains that this application may include more than one patentably and non-obviously distinct invention. The Applicant hereby asserts that the disclosure of this application may include more than one invention, and, in the event that there is more than one invention, that these inventions may be patentable and non-obvious one with respect to the other.

### BRIEF DESCRIPTION OF THE DRAWINGS

Each sticker set has a theme. A set includes a preprinted background theme sheet with a variety of pressure sensitive die cut labels to apply to the background sheet of different sizes, shapes and objects that match correspondingly to the theme.

FIG. 1 is a top view of a background theme sheet of a girl with a butterfly in an open field.

FIG. 2 is a side view of the background theme sheet shown in FIG. 1.

FIG. 3 is a top view of a sticker set for the matching theme shown in FIG. 1 of butterflies.

FIG. 4 is a side view of the sticker set shown in FIG. 3, for the corresponding theme sheet in FIG. 1.

FIG. 5 is a top view of a background theme sheet of an airport and city with clouds in the sky.

FIG. 6 is a top view of a sticker set for the matching theme shown in FIG. 5 of airplanes.

FIG. 7 is a top view of a background theme sheet of children at the beach.

FIG. 8 is a top view of the sticker set for the matching theme shown in FIG. 7 of sea shells and crabs.

FIG. 9 is a top view of a background theme sheet of the moon in the sky of stars above a grassy field.

FIG. 10 is a top view of the sticker set for the matching theme shown in FIG. 9 of fire flies.

FIG. 11 is a top view of a background theme sheet of a jewelry box.

FIG. 12 is a top view of the sticker set for the matching theme shown in FIG. 11 of jewelry.

FIG. 13 is a top view of a background theme sheet of a tool box.

FIG. 14 is a top view of the sticker set for the matching theme shown in FIG. 13 of tools.

FIG. 15 is a top view of a background theme sheet of a ocean floor.

FIG. 16 is a top view of the sticker set for the matching theme shown in FIG. 15 of mermaids.

FIG. 17 is a top view of a background theme sheet of the sky.

FIG. 18 is a top view of the sticker set for the matching theme shown in FIG. 17 of kites.

FIG. 19 is a top view of a background theme sheet of a candy jar.

FIG. 20 is a top view of the sticker set for the matching theme shown in FIG. 19 of candy.

FIG. 21 is a top view of a background theme sheet of a shape border.

FIG. 22 is a top view of the sticker set for the matching theme shown in FIG. 21 of 3-D shapes.

FIG. 23 is a top view of a background theme sheet of a fish tank.

FIG. 24 is a top view of the sticker set for the matching theme shown in FIG. 23 of tropical fish.

FIG. 25 is a top view of the sticker set for a matching theme shown of sporting equipment for sports fields.

FIG. 26 is a top view of a background theme sheet of a vase of ferns and greenery for flower bud stickers.

FIG. 27 is a top view of a background theme sheet of the sea floor.

FIG. 28 is a top view of the sticker set for the matching theme shown in FIG. 27 of sea horses.

FIG. 29 is a top view of a background theme sheet of a chalk board for letters with corresponding objects.

FIG. 30 is a top view of a background theme sheet of the ocean.

FIG. 31 is a top view of the sticker set for the matching theme shown in FIG. 30 of boats.

FIG. 32 is a top view of a background theme sheet with fish stickers from the matching theme set being applied to the background sheet.

FIG. 33 is a top view of a background theme sheet of letters with corresponding object stickers from the matching theme set being applied to the background sheet.

FIG. 34 is a top view of background theme sheets of additional themes.

FIG. 35 is a top view of the sticker set for additional themes.

### DESCRIPTION OF THE PREFERRED EMBODIMENT

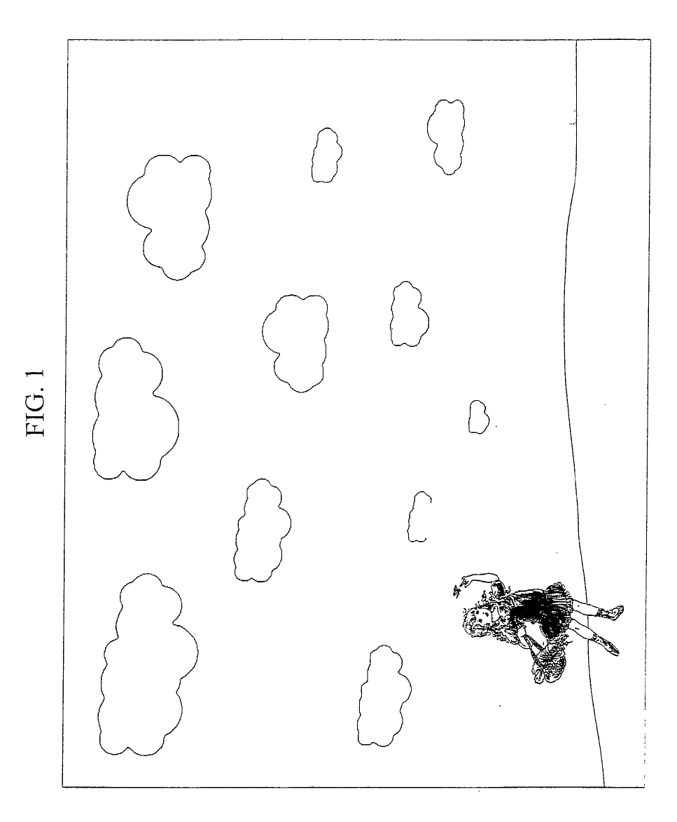

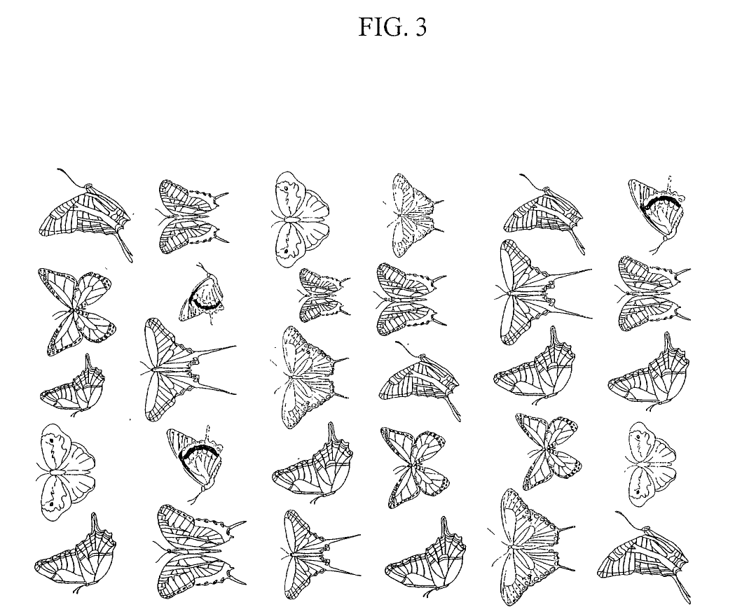

Potty stickers and behavioral modification stickers are a toilet training aide and discipline and teaching tool, as well as, a fun and entertaining craft for young children. The stickers, as shown in FIG. 3, are designed to motivate and encourage a child to want to succeed in potty training and motivational learning. Children apply and arrange colorful design element stickers of a set theme to a preprinted colorful designed background sheet, as shown in FIG. 1, that corresponds with the sticker item theme.

Inside each sticker package is a background theme sheet, as shown in FIG. 1, and a set of matching theme pressure sensitive labels, as shown in FIG. 3.

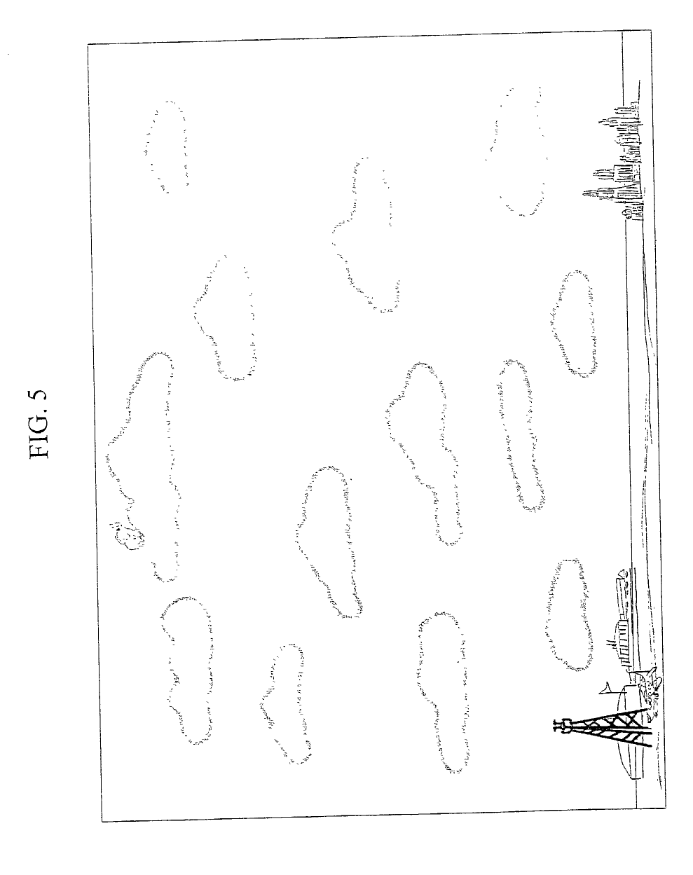

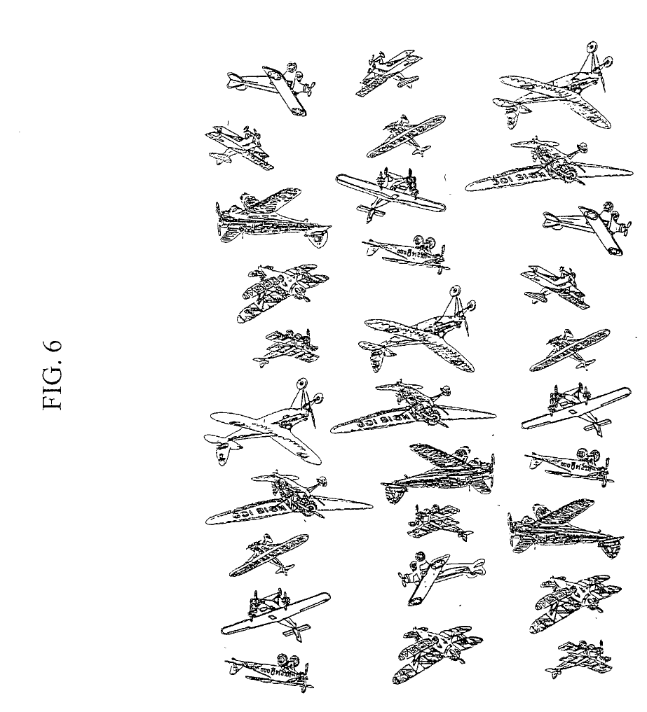

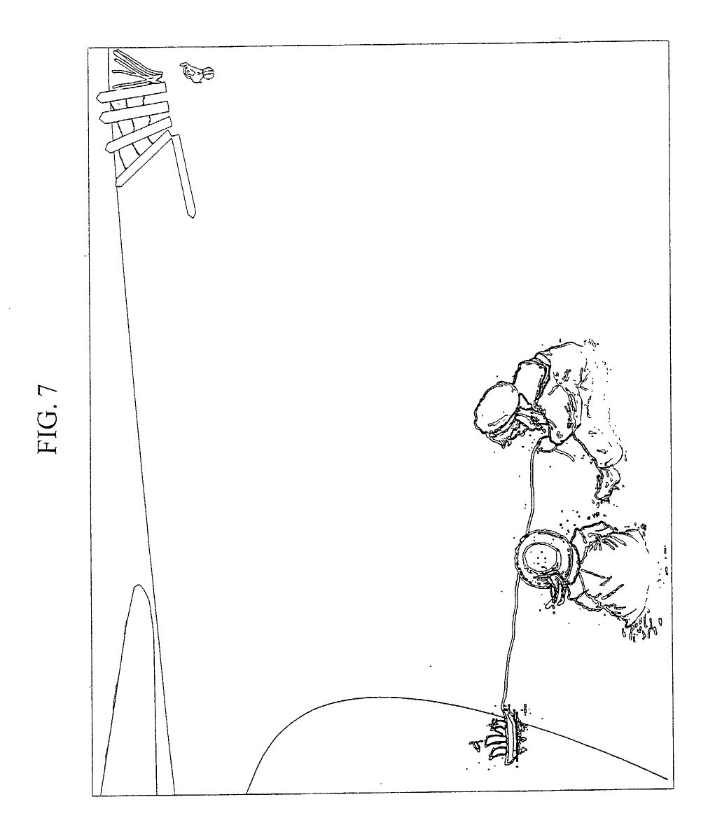

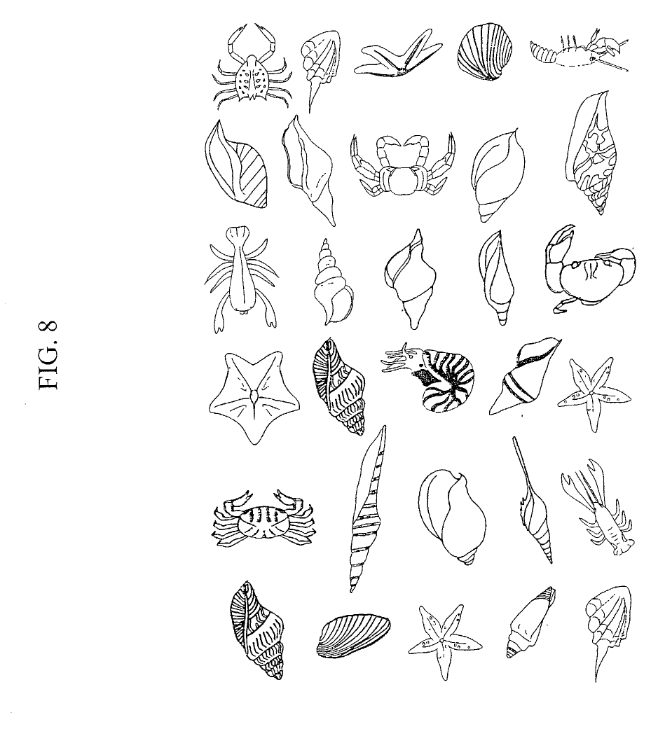

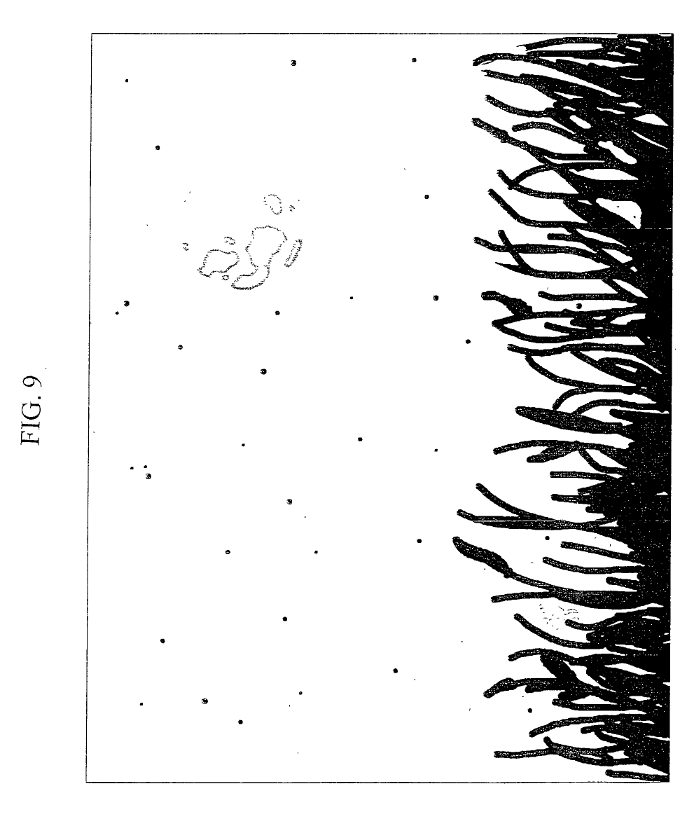

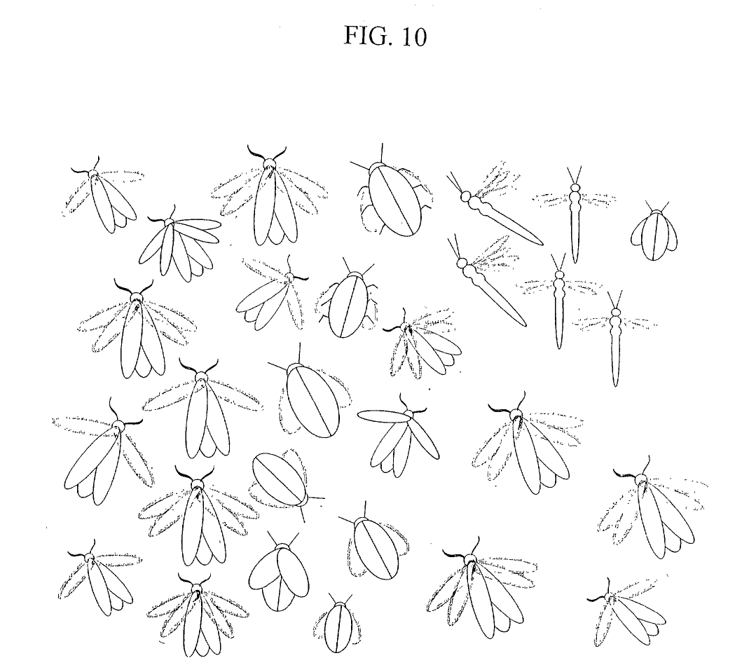

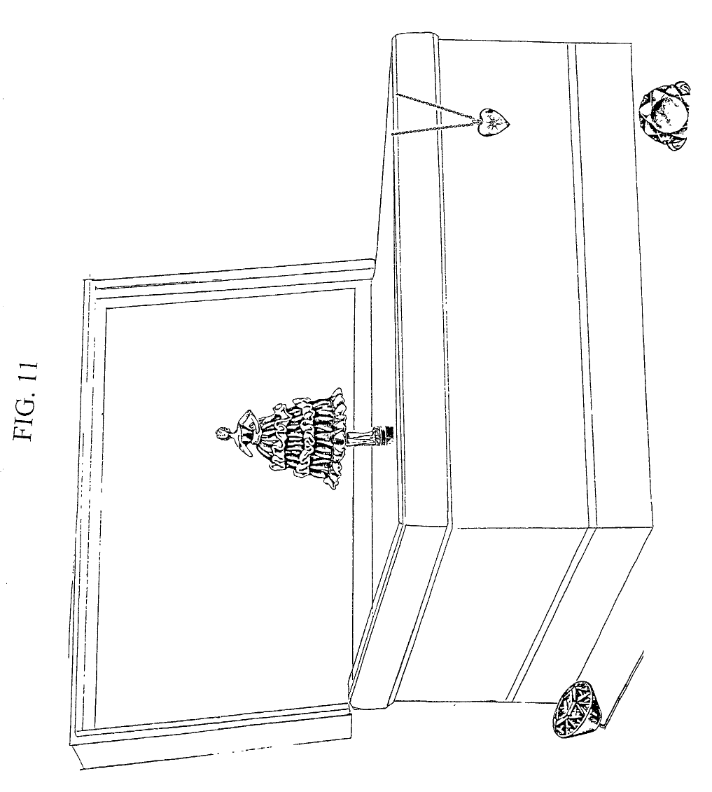

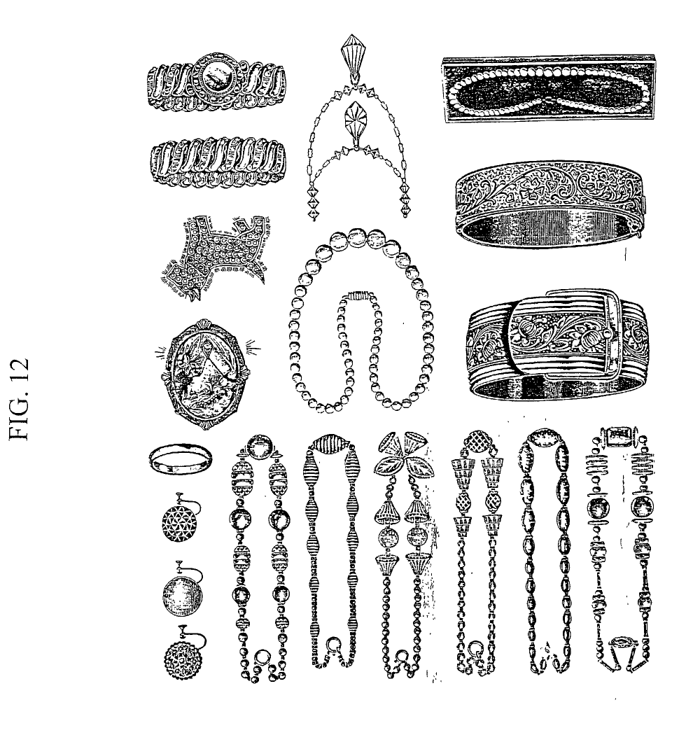

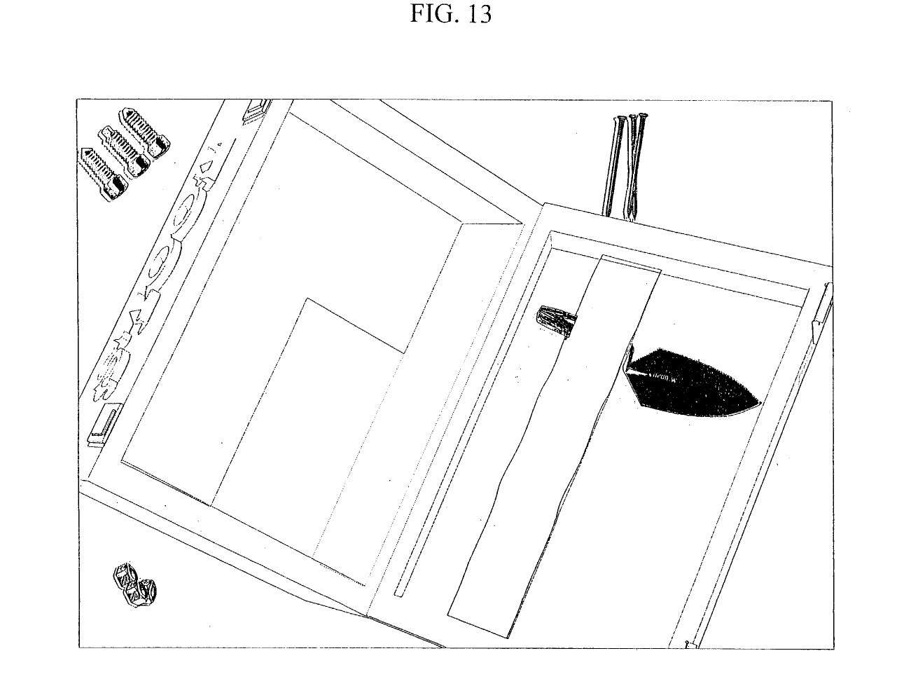

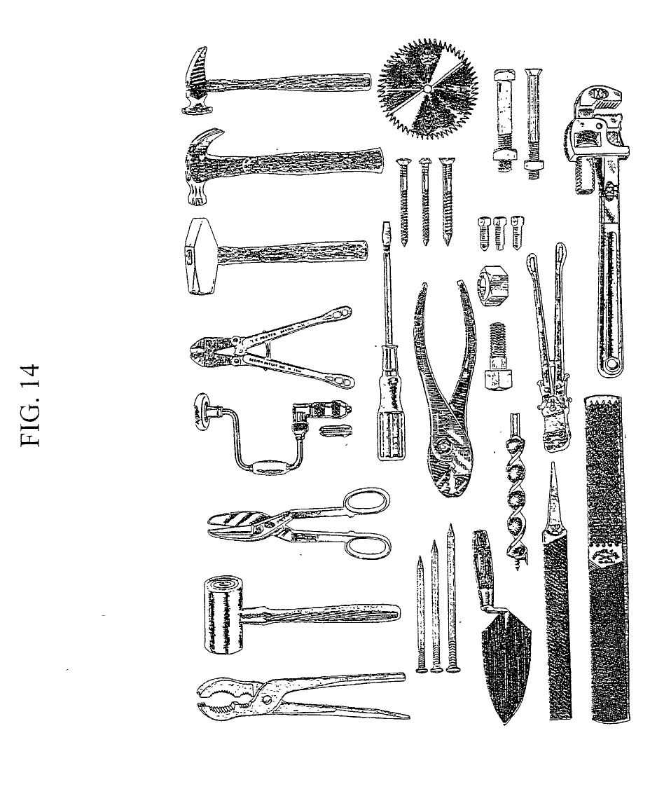

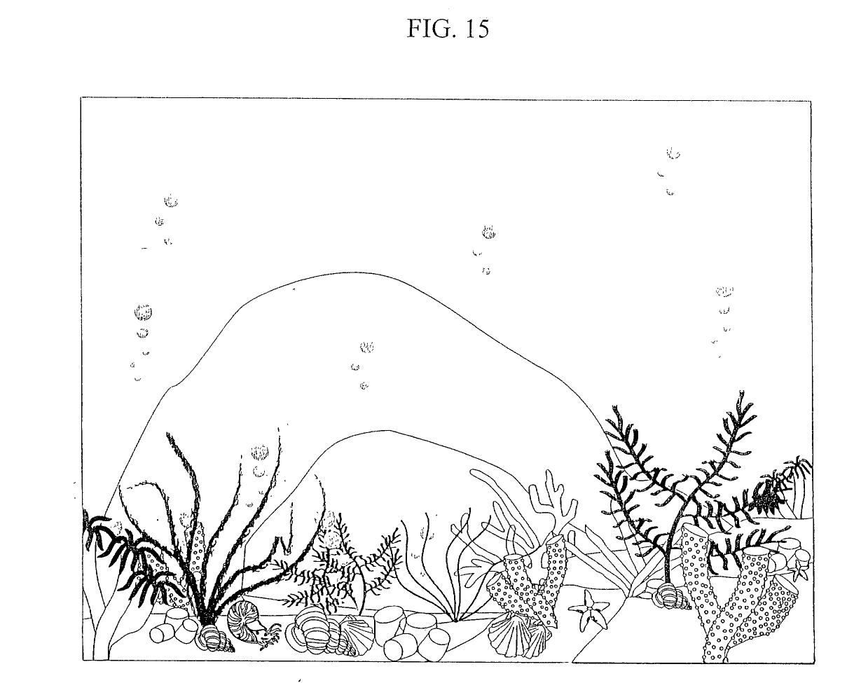

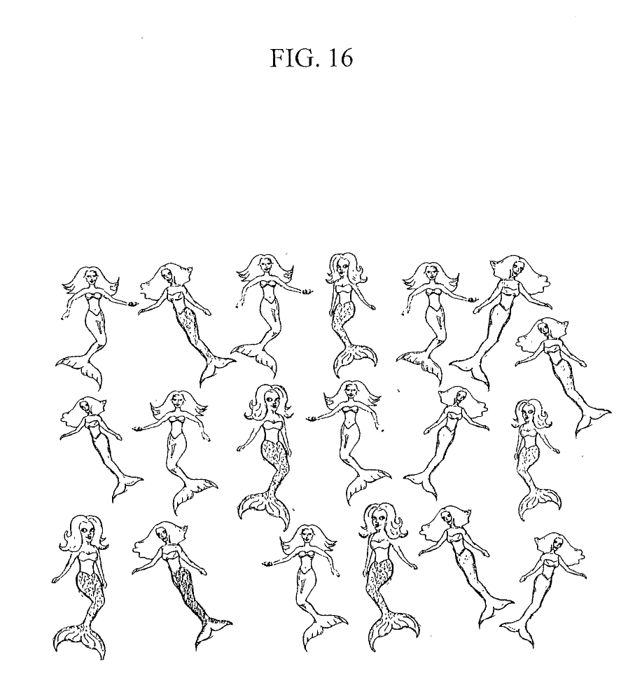

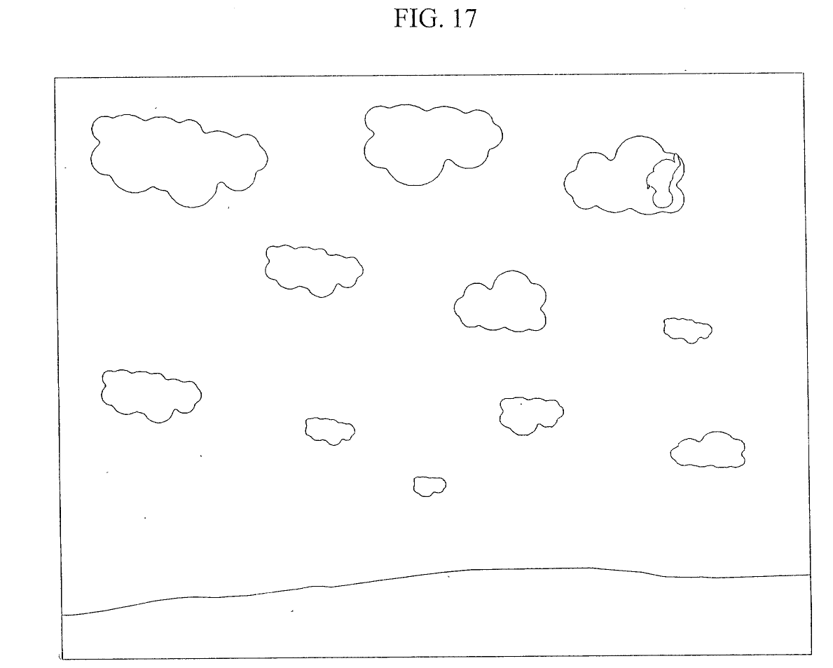

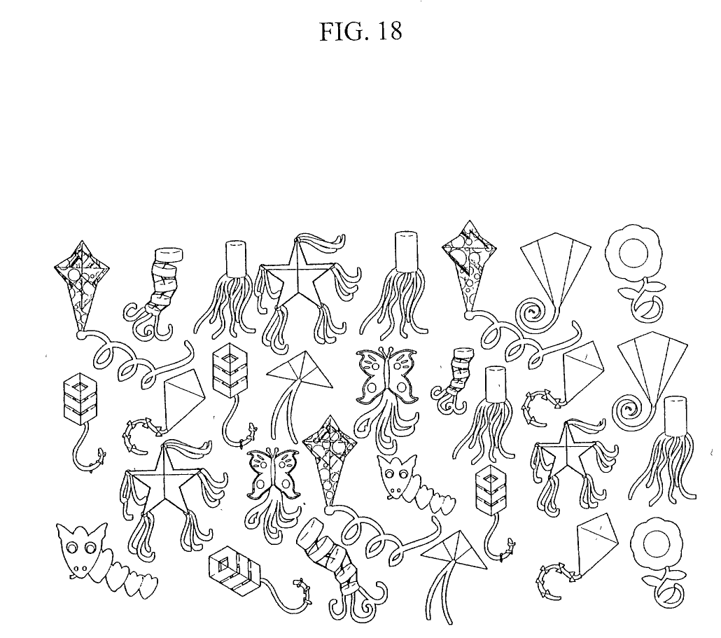

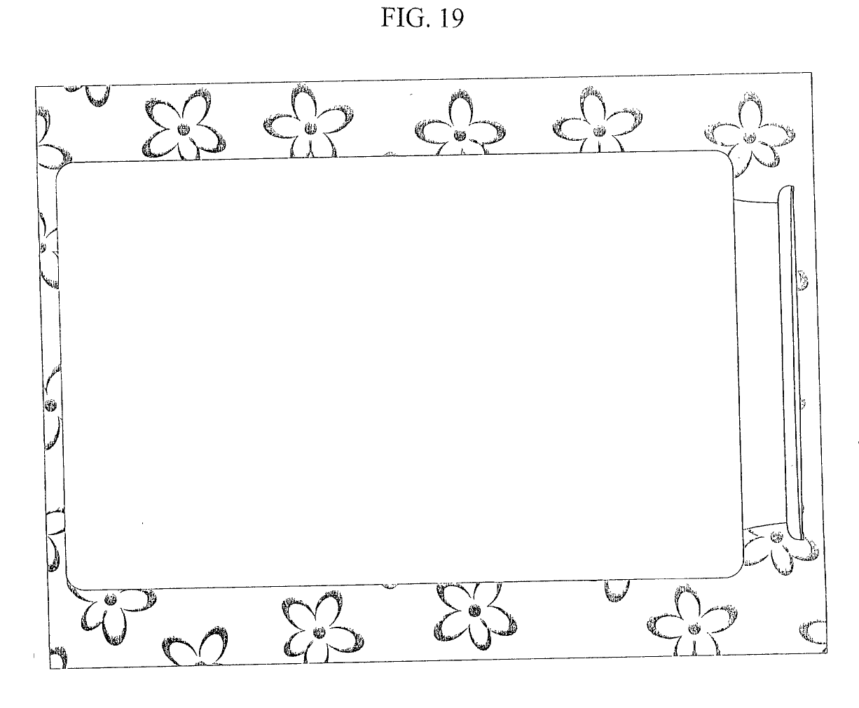

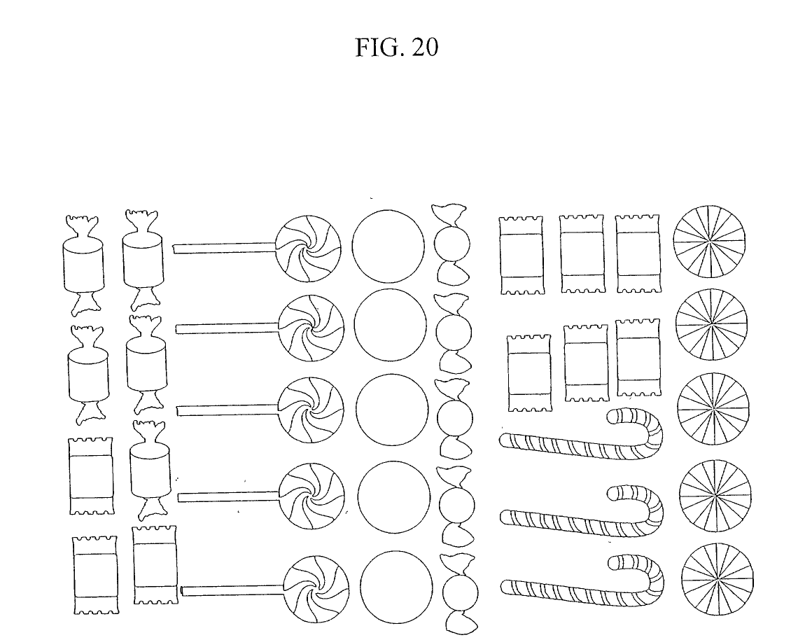

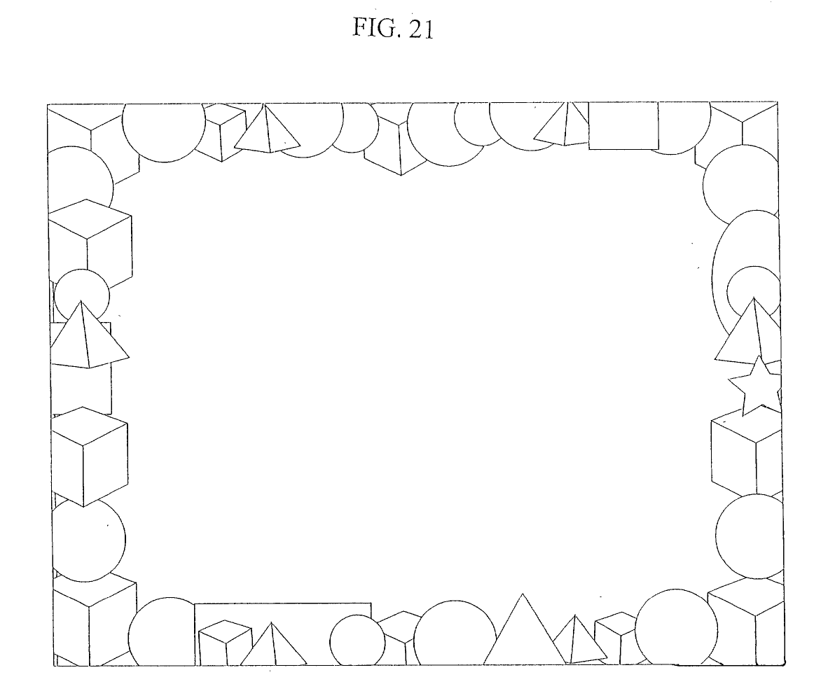

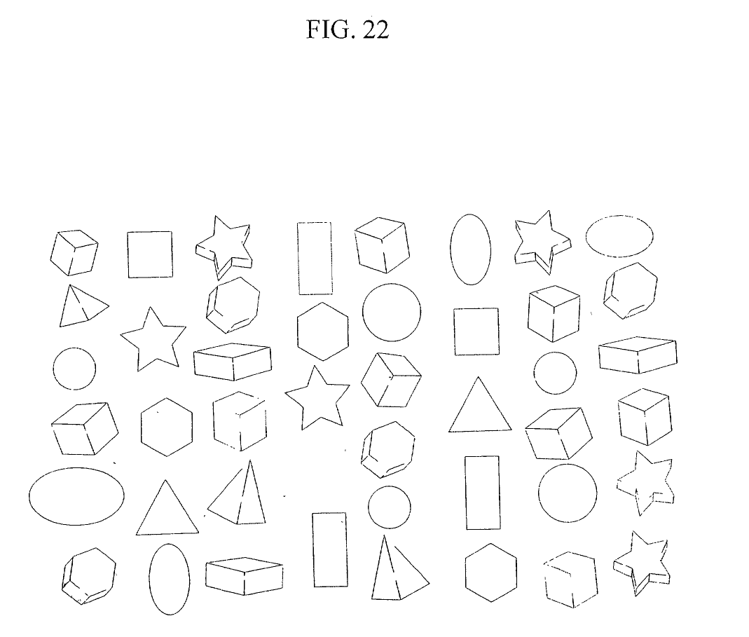

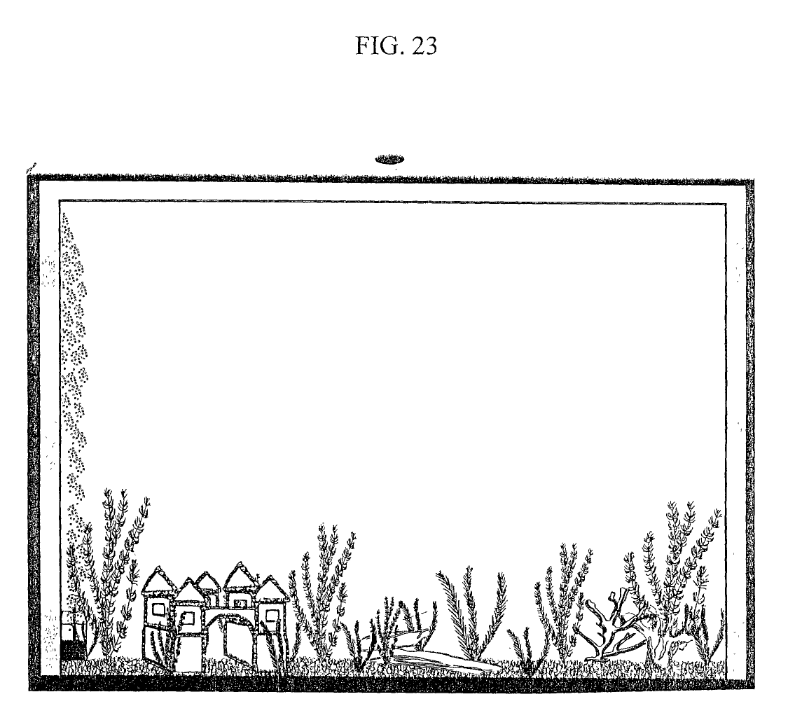

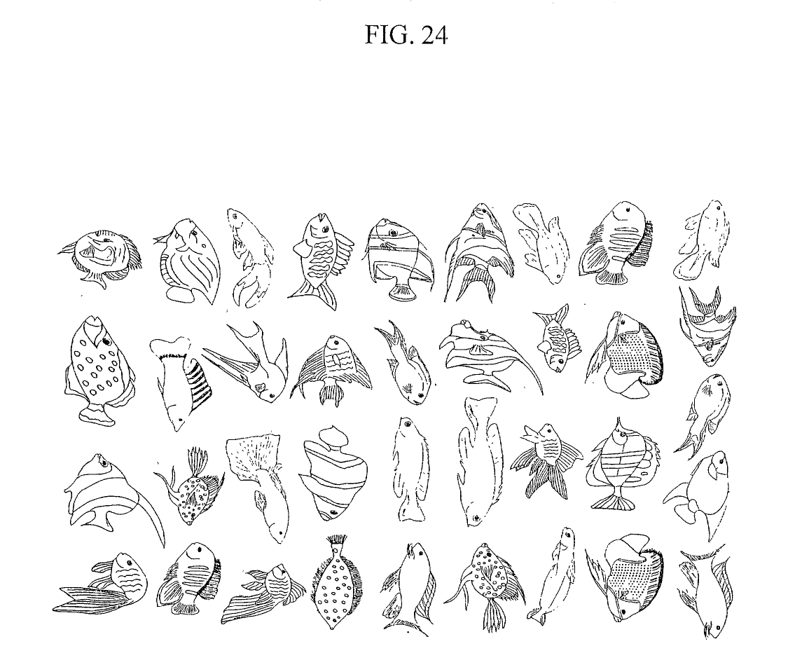

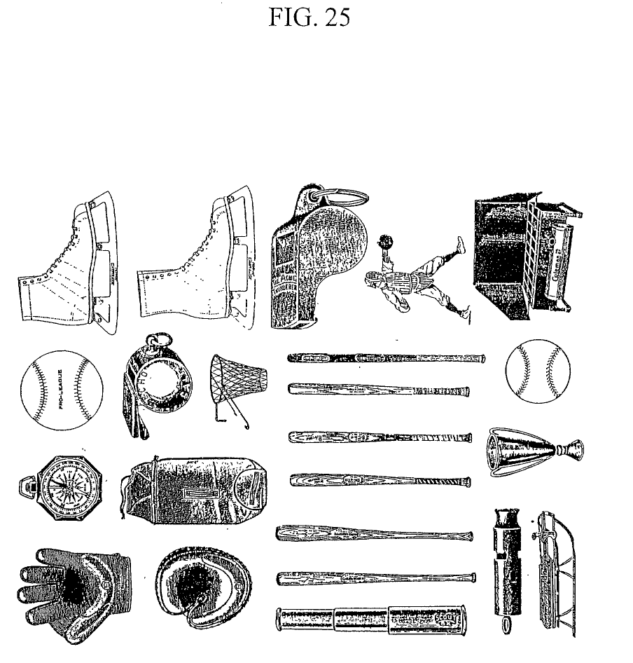

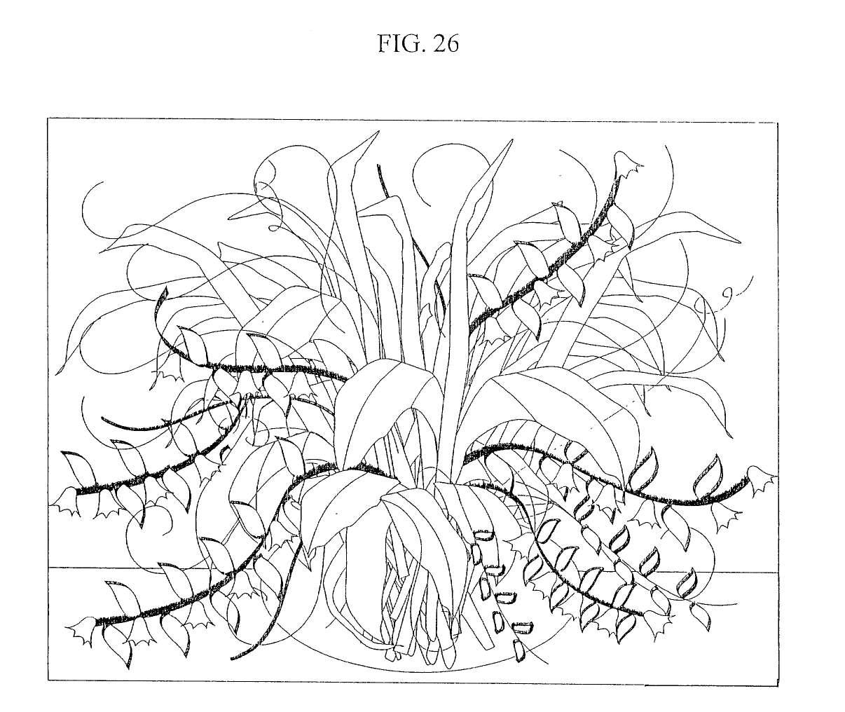

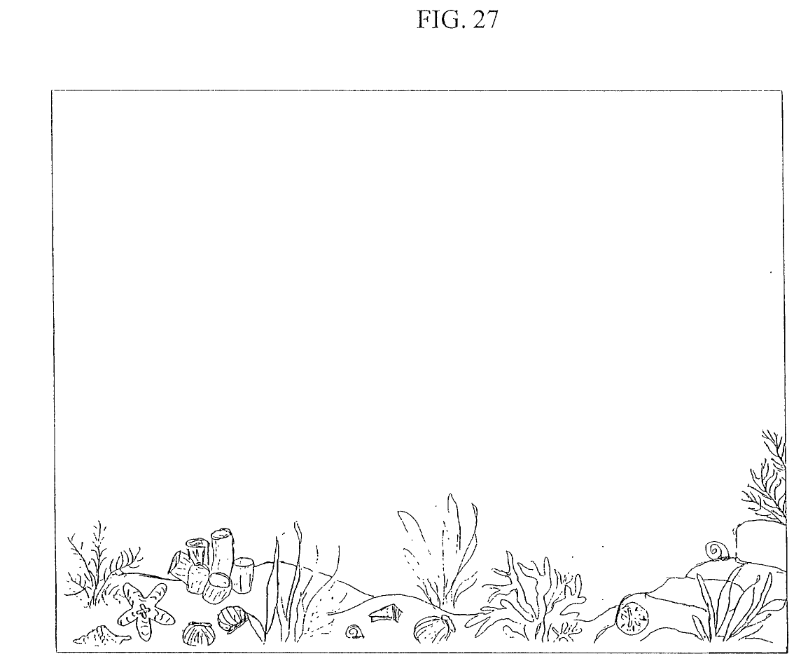

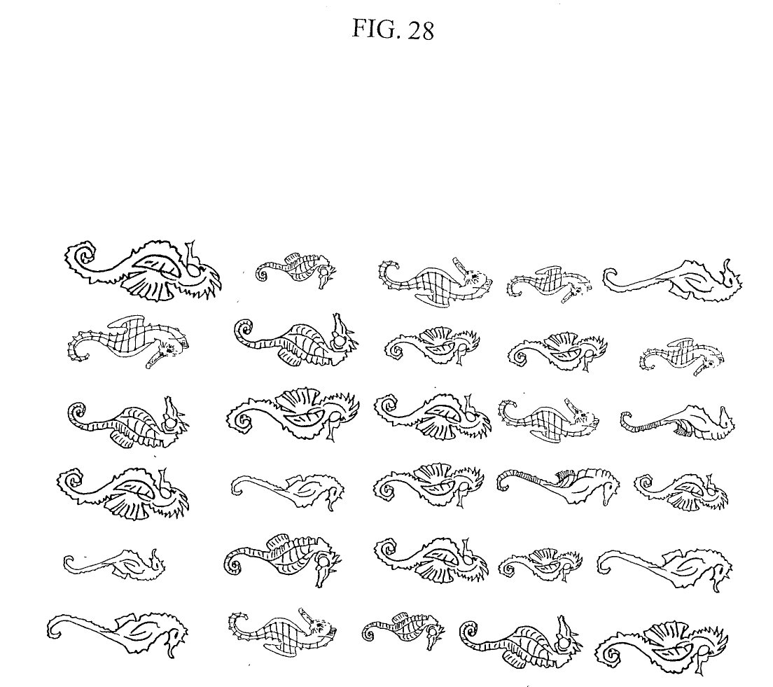

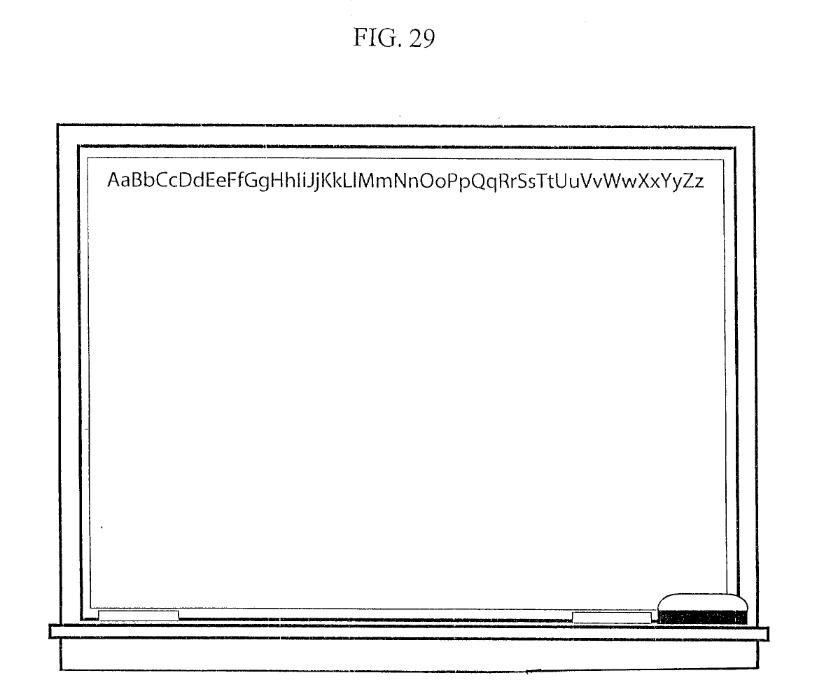

FIGS. 5-31 show various exemplary embodiments of sticker sets and theme sheets, similar to those shown in FIGS. 1 and 3. For example, FIG. 5 shows a background theme sheet. A sky scene is depicted with clouds. In addition, an airport and city skyline are visible. FIG. 6 shows a view of a sticker set containing images of aircraft. In one embodiment of the present invention, the aircraft sticker set (FIG. 6) would be used in conjunction with the sky scene background sheet (FIG. 5). Upon completion of a desired task, a child would be given one or more of the aircraft stickers to place on the sky scene background sheet. In this manner, the child could create a colorful sky scene with aircraft flying over a city. The sky background theme sheet and corresponding aircraft sticker set are but one of many possible embodiments of background themes and corresponding sticker sets that are within the scope of the present invention.

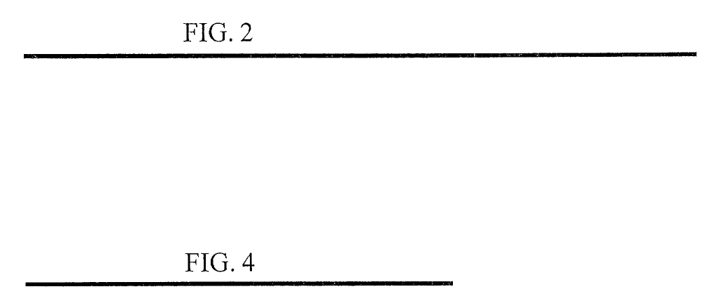

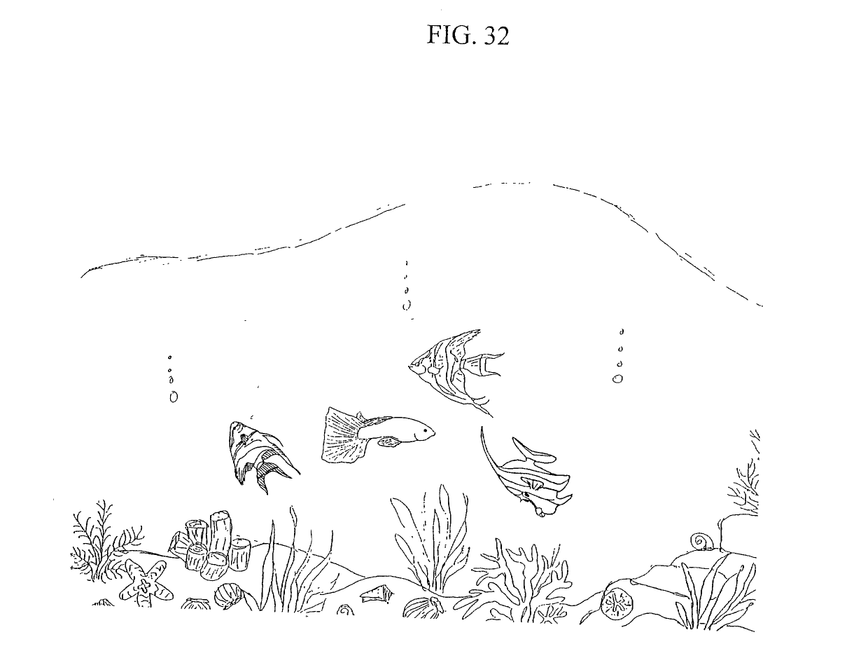

FIG. 32 illustrates the use of the invention for toilet training and motivational learning. In this particular example, the background sheet has an underwater or aquatic scene with water and underwater plants and creatures. The fish shown, in this particular embodiment, are stickers that have been placed on the background sheet by a child (not shown) who has completed a desired task, such as a household chore or successful use of the toilet or potty. This particular example shows a stage one sticker and background sheet set for very young children. Please note that the fish stickers are placed randomly and facing in multiple directions. This permits children the freedom to select where the stickers should go and how they will be oriented with respect to the background without essentially any concern as to a proper or correct orientation. FIGS. 1-26 also show embodiments to be used in stage one.

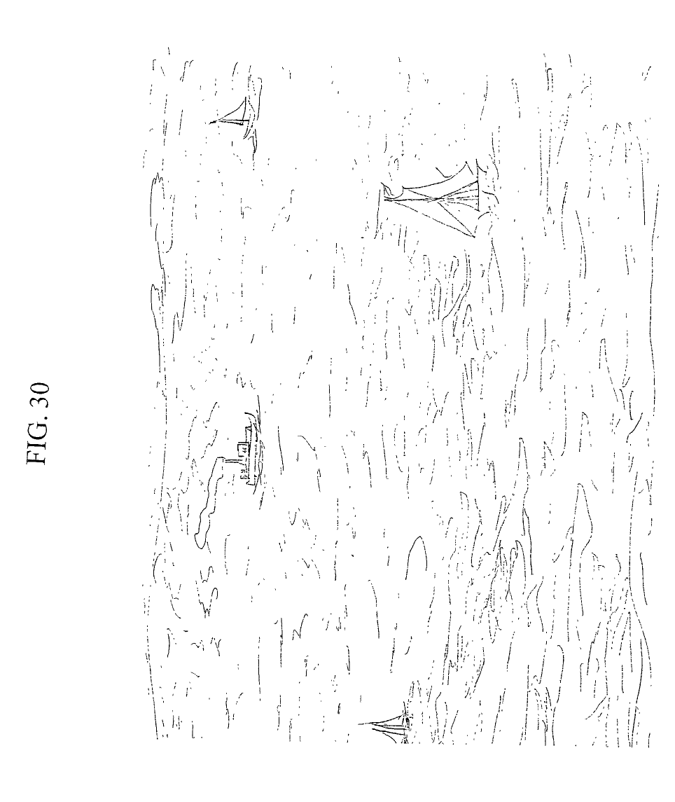

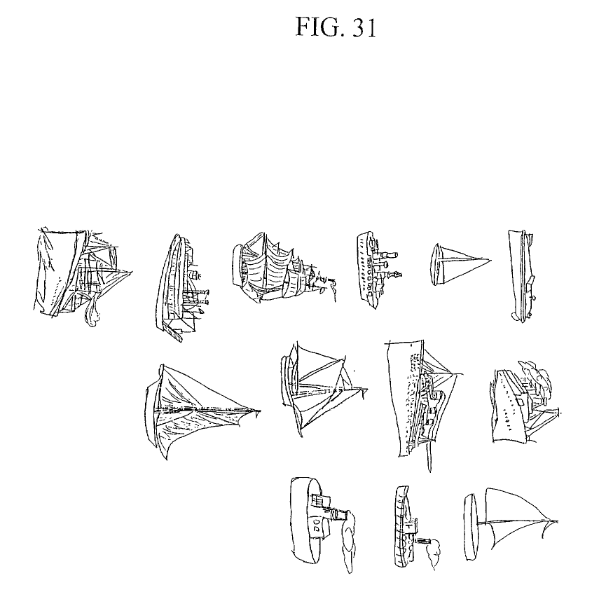

In contrast to FIG. 32, FIGS. 30 and 31 illustrate an embodiment of the invention for use by older children in stage two of the present invention. In this particular embodiment, an ocean surface scene is shown in the background and the sticker set contains images of boats. Older children who can comprehend the proper positioning of boats on the water will place their stickers on the sheet such that the bottom of the boats face the water surface. While younger children would have a tendency to place the stickers at random regardless of position, an older child may successfully construct a more complex picture by placing the stickers in a desired position and orientation with respect to the scene on the background sheet. FIGS. 27-31 show further embodiments of stage two stickers and background sheets.

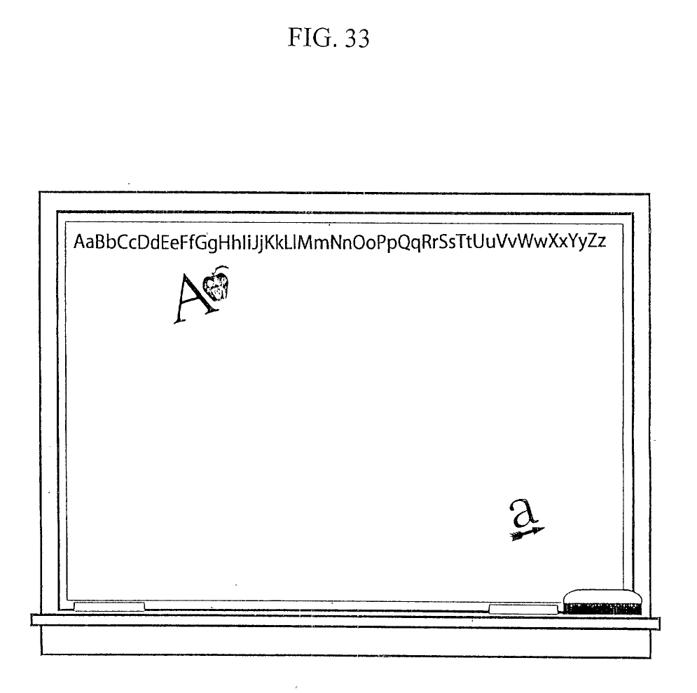

FIG. 33, which is another embodiment for stage two, illustrates the use of the invention for educational purposes, such as teaching the alphabet and spelling, shapes, numbers, and the letters can be conveniently used either alone or in conjunction or association with pictorial representations such as are illustrated in the other figures.

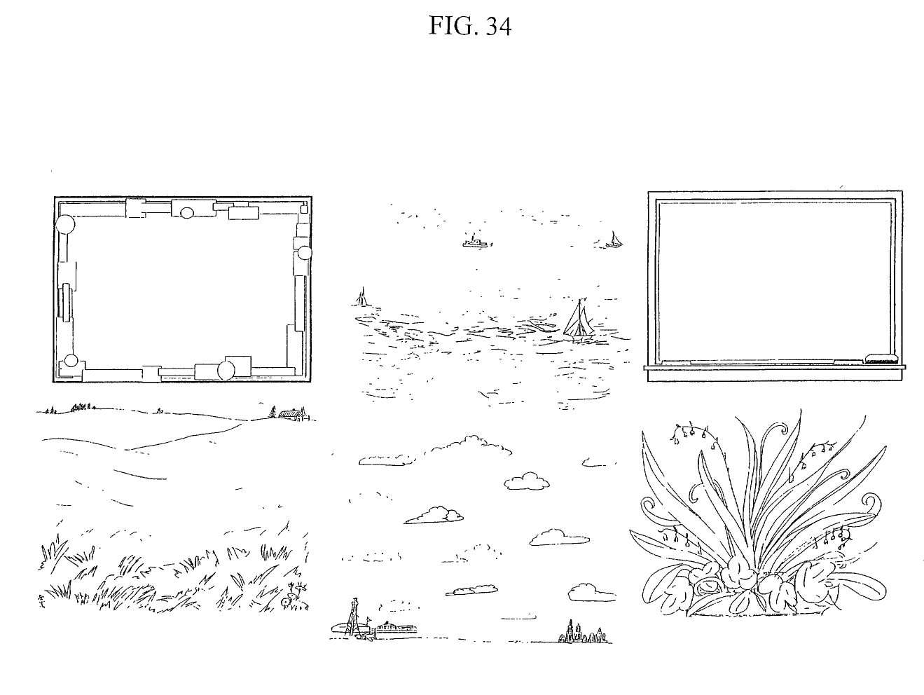

FIG. 34 is a top view of background theme sheets of additional themes.

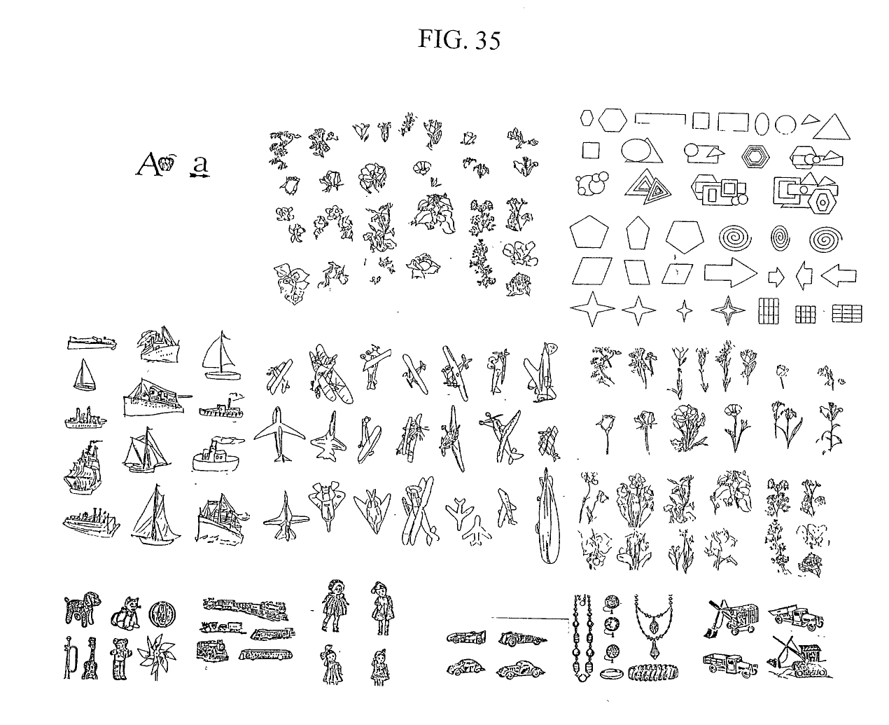

FIG. 35 is a top view of the sticker sets for additional themes.

One feature of the invention resides broadly in an improved toilet (the words toilet and potty mean the same thing) training aide system and behavioral modification learning for motivational teaching for inspiring infants as young as less than a year old up to children of the approximate age of seven years old (hereafter referred to as children or toddlers) using a preprinted background design graphic element with a particular theme imprinted onto a surface such as, but not limited to, paper with an accompanying second sheet of approximately thirty individual colorful theme related design elements imprinted onto a surface such as, but not limited to, pressure sensitive label stock and custom die cut to be used as an improved rewarding system toilet training aide and behavioral modification learning for motivational teaching, comprising the following steps of: 1a) selecting one reward sticker of a specific pressure sensitive label by the child or parent when the child successfully tries to toilet train by sitting on the toilet or given for behavioral modification regularly expected, and daily or weekly tasks to be done by the toddler or child, such as brushing teeth, putting dirty clothes in hamper, put shoes away, putting clothes on; 1b) selecting two reward stickers of specific pressure sensitive labels by the child or parent when the child successfully urinates in the toilet or behavioral modification for specific little special jobs done around the house to help out, such as washing hands, emptying the trash, setting the dinner table, unloading the dishwasher, feeding the pet, cleaning up toys, folding clothes, helping around house or yard; 1c) selecting three reward stickers of specific pressure sensitive labels by the child or parent when the child successfully defecates in the toilet or a new behavioral modification is being taught to be learned by the toddler or child or for simply saying thank you, playing well with others, making the bed, tieing shoes, cleaning up after meals, doing homework or studies, 2a) rewarding the child by handing them one reward pressure sensitive label that the child or adult has chosen; 2b) rewarding the child by handing them two reward pressure sensitive labels that the child or adult has chosen; 2c) rewarding the child by handing them three reward pressure sensitive labels that the child or adult has chosen; 3) then provide the child with a preprinted background design graphic element with a particular theme imprinted onto a surface such as, but not limited to, paper that matches the theme related pressure sensitive labels; 4) the child then places the label(s) where ever and however they desire onto the preprinted background sheet of that particular theme.

Another feature of the invention resides broadly in the fact that the sticker sets are an improved and portable toilet training aide and behavioral modification learning tool.

Yet another feature of the invention resides broadly in the fact that the sticker sets come in many themes. Each theme allows children creativity and imagination development while reinforcing a positive and rewarding system for toilet training and behavioral modification.

Still another feature of the invention resides broadly in the fact that the sticker sets are colorful pressure sensitive labels which children place onto a preprinted background sheet related to various themes.

A further feature of the invention resides broadly in the fact that each individual theme set has a theme background design which is imprinted onto a surface such as, but not limited to, paper and has a variety of approximately thirty individual colorful theme related designs imprinted onto a surface such as, but not limited to, pressure sensitive label stock on a second sheet.

Another feature of the invention resides broadly in the fact that each set of stickers belongs to its own individual theme background sheet to apply each of the stickers on to.

Yet another feature of the invention resides broadly in creating an interesting scene, picture, or educational topic for each of the pressure sensitive label stock and background theme sheet.

Furthermore the most important feature of the invention resides broadly in the creation of the design in stage one of the toilet training and behavioral modification sets that no matter where a child places a sticker they are correct building self esteem and confidence in themselves for the youngest of toddlers who yet do not talk.

Yet another feature of the invention resides broadly in the creation of the design in stage two of the toilet training and behavioral modification sets that allows advanced and older children to learn, create a picture and reinforce them in a positive way with a newly creative learning tool and aide.

Still another feature of the invention resides broadly in the fact that the child selects a sticker for a successful toilet training or behavioral modification experience and then places it anywhere he or she desires on the preprinted background sheet; selecting a sticker is a rewarding experience in itself and promotes decision making skills and motor skills.

A further feature of the invention resides broadly in the fact that, in our fast paced world, single parent house holds, multi children households, all parents and care givers, and child care systems will all benefit and have a portable, consistent reinforcement system during toilet training and behavioral modification learning. The sticker sets travel well, they are portable, uncomplicated, not bulky or cumbersome, truly unisex, educational and creative teaching and learning aids.

Another feature of the invention resides broadly in the concept for a toilet training aide, as shown and described.

Another feature of the invention resides broadly in the concept for a behavioral modification teaching and learning aide, as shown and described.

Yet another feature of the invention resides broadly in a method for a toilet training aide, as shown and described.

Still another feature of the invention resides broadly in the elements for a toilet training aide, as shown and described.

Still another feature of the invention resides broadly in the elements for a behavioral modification teaching and learning aide, as shown and described.

A further feature of the invention resides broadly in the design and concept of the elements for a toilet training aide and behavioral modification teaching and learning tool, as shown and described.

Another feature of the invention resides broadly in an improved toilet training aide system and behavioral modification teaching and learning tool, with small graphics on one side and is adapted to be attached to the background scene in any location, perhaps as a pressure sensitive label.

Yet another feature of the invention resides broadly in an improved toilet training aide system and behavioral modification teaching and learning tool, which is portable for daily travel with the child.

Still another feature of the invention resides broadly in an improved toilet training aide system and behavioral modification teaching and learning tool, used and directed towards educational purposes for toilet training and behavioral modification learning for children.

A further feature of the invention resides broadly in an improved toilet training aide system to provide a means for facilitating the toilet training and behavioral modification teaching and learning, of children.

Another feature of the invention resides broadly in an improved toilet training aide system to provide a method for promoting potty training.

Yet another feature of the invention resides broadly in an improved toilet training aide system to provide a method for reducing the volume of disposable diapers in landfills.

Still another feature of the invention resides broadly in an improved toilet training aide system and behavioral modification teaching and learning tool for selecting a reward type by the parent or care giver and child.

A further feature of the invention resides broadly in an improved toilet training aide system rewarding the child with the previously chosen reward type with a successful toilet training experience (perhaps one pressure sensitive label for sitting, two for urination and three for defecation).

Another feature of the invention resides broadly in an improved toilet training aide system of positive reinforcement with guidance for toilet training children.

Yet another feature of the invention resides broadly in an improved toilet training aide system and behavioral modification teaching and learning tool of providing and displaying a design which comprises forming the design from a piece of sheet material showing a theme displaying background image

Still another feature of the invention resides broadly in an improved toilet training aide system and behavioral modification teaching and learning tool wherein the pressure sensitive labels match appropriately in themes to form a set of approximately thirty on a sheet.

A further feature of the invention resides broadly in an improved toilet training aide system and behavioral modification teaching and learning tool wherein the pressure sensitive labels match appropriately in themes and when applied by the child may form an educational tool, a specific learning experience, a scene or picture.

Another feature of the invention resides broadly in an improved toilet training aide system and behavioral modification teaching and learning tool to stimulate a child [symbol] s imagination.

Yet another feature of the invention resides broadly in an improved toilet training aide system and behavioral modification teaching and learning tool having pressure sensitive labels produced in various shapes, sizes, colors and themes.

Still another feature of the invention resides broadly in an improved toilet training aide system to provide a toilet training aide for children.

Yet another feature of the invention resides broadly in a behavioral modification and learning system to provide a teaching aide for children.

A further feature of the invention resides broadly in a behavioral modification and learning system to provide a method for teaching children.

Still another feature of the invention resides broadly in an improved toilet training aide system to provide a method for toilet training children.

Another feature of the invention resides broadly in an improved toilet training aide system to provide a portable toilet training aide.

Another feature of the invention resides broadly in an improved behavioral modification and learning system to provide a portable teaching aide.

Yet another feature of the invention resides broadly in an improved toilet training aide system and a behavioral modification and learning system to provide an aide that can go everywhere, everyday without inconvenience and without taking up space.

Still another feature of the invention resides broadly in an improved toilet training aide system and a behavioral modification and learning system to provide parents and care givers with an avenue of keeping with consistency for the child with ease and without inconveniencing anyone.

A further feature of the invention resides broadly in an improved toilet training aide and a behavioral modification and learning system to provide busy parents and care givers with an innovative way to entice children to toilet train and to learn specific behaviors at an earlier age.

Another feature of the invention resides broadly in an improved toilet training aide and a behavioral modification and learning system to provide ease and comfort on daily trips, vacations and long journeys without disrupting a child's training experience and preventing setbacks due to inconsistent toilet training and behavioral learning.

Yet another feature of the invention resides broadly in an improved toilet training aide system that can also be used as any type of reward kit or discipline aide.

Still another feature of the invention resides broadly in an improved toilet training aide and a behavioral modification and learning system that is uncomplicated, not cumbersome or bulky, does not take up too much space, is a true unisex system, and travels well daily as well as on vacations.

A further feature of the invention resides broadly in an improved toilet training aide and a behavioral modification and learning system providing the ability to be concise in the method of rewarding.

Another feature of the invention resides broadly in an improved toilet training aide and a behavioral modification and learning system providing a kit which is fun to play with for the children.

Yet another feature of the invention resides broadly in an improved toilet training aide and a behavioral modification and learning system for the teaching of a sibling or playmate in the use of the toilet training aide with success and learned behavior.

Still another feature of the invention resides broadly in an improved toilet training aide and a behavioral modification and learning system that may be embodied in various forms.

One feature of the invention relates resides broadly in an improved toilet (the words toilet and potty mean the same thing) training aide and behavioral modification and learning system inspiring infants as young as less than a year old up to children of the approximate age of seven years old (hereafter referred to as children or toddlers) using a preprinted background design graphic element with a particular theme imprinted onto a surface such as paper, but not limited to, with an accompanying second sheet of approximately thirty individual colorful theme related design elements imprinted onto a surface such as pressure sensitive label stock and custom die cut, but not limited to, to be used as an improved rewarding system toilet training aide and behavioral modification and learning for positive motivational teaching. Through careful design the stage one sticker sets are made for younger toddlers. In stage one no matter how or where a child places a sticker onto the theme background sheet they are correct; resulting in a positive reinforcement reward system which encourages the child and builds self esteem. In stage two a child can design and create a picture or scene of a specific theme from the matching background sheet and stickers; resulting in a motivational learning experience which is fun and provokes imagination development; comprising the following steps of:

a) selecting one reward sticker of a specific pressure sensitive label by the child or parent when the child successfully tries to toilet train by sitting on the toilet or given for behavioral modification regularly expected, daily or weekly tasks to be done by the toddler or child—such as brushing teeth, putting dirty clothes in hamper, put shoes away, putting on clothes OR

b) selecting two reward stickers of specific pressure sensitive labels by the child or parent when the child successfully urinates in the toilet or behavioral modification for specific little special jobs done around the house to help out—washing hands, empty trash, setting the dinner table, unloading the dishwasher, feed pet, clean up toys, fold clothes, help around house or yard OR

c) selecting three reward stickers of specific pressure sensitive labels by the child or parent when the child successfully defecates in the toilet or a new behavioral modification is being taught to be learned by the toddler or child or for simply saying thank you, playing well with others, making the bed, tieing shoes, cleaning up after meals, doing homework or studies THEN

d) rewarding the child by handing them one pressure sensitive label that the child or adult has chosen OR

e) rewarding the child by handing them two pressure sensitive labels that the child or adult has chosen OR

f) rewarding the child by handing them three pressure sensitive labels that the child or adult has chosen

g) then provide the child with a preprinted background design graphic element with a particular theme imprinted onto a surface such as, but not limited to, paper (perhaps which could be taped to the back of the bathroom door or kitchen refrigerator that matches the theme related pressure sensitive label(s) given to the child

h) the child then places the label(s) where ever and however they desire onto the preprinted background sheet of that particular theme.

Another feature of the invention resides broadly in the fact that the sticker sets are an improved and portable toilet training aide system and behavioral modification teaching and learning tool.

Yet another feature of the invention resides broadly in the fact that the sticker sets come in many themes. Each theme allows children creativity and imagination development while reinforcing a positive and rewarding system for toilet training and behavior modification.

Still another feature of the invention resides broadly in the fact that the sticker sets are colorful pressure sensitive labels in which children place onto a preprinted background related to various themes.

A further feature of the invention resides broadly in the fact that each individual theme set has a theme background design which is imprinted onto a surface such of paper, but not limited to, and has a variety of approximately thirty individual colorful theme related designs imprinted and custom die cut onto a surface such as pressure sensitive label stock, but not limited to, on a second sheet.

Another feature of the invention resides broadly in the fact that each set of stickers belongs to its own individual theme background sheet to apply each of the stickers on to.

Yet another feature of the invention resides broadly in creating an interesting scene, picture, or educational topic.

Still another feature of the invention resides broadly in the fact that the child selects a sticker for a successful potty experience or behavior modification and then places it anywhere they desire on the preprinted background sheet.

A further feature of the invention resides broadly in the fact that, in our fast paced world, single parent households, multi children households, all parents and care givers, and child care systems will all benefit and have a portable, consistent reinforcement system during toilet training and behavior modification. The sticker sets travel well, they are portable, uncomplicated, not bulky or cumbersome, truly unisex, educational and creative toilet training aids and behavioral modification learning tools.

Another feature of the invention resides broadly in the concept for a toilet training aide and behavioral modification teaching and learning tool system, as shown and described.

Yet another feature of the invention resides broadly in a method for a toilet training aide and behavioral modification teaching and learning tool system, as shown and described.

Still another feature of the invention resides broadly in the elements for a toilet training aide and behavioral modification teaching and learning tool system, as shown and described.

A further feature of the invention resides broadly in the design and concept of the elements for a toilet training aide and behavioral modification teaching and learning tool system, as shown and described.

Another feature of the invention resides broadly in an improved toilet training aide and behavioral modification teaching and learning tool system with small graphics printed on one side and is adapted to be attached to the background scene in any location on the background sheet, perhaps as a pressure sensitive label.

Yet another feature of the invention resides broadly in an improved toilet training aide and behavioral modification teaching and learning tool system which is portable for daily travel with the child.

Still another feature of the invention resides broadly in an improved toilet training aide and behavioral modification teaching and learning tool system used and directed towards educational purposes for toilet training children and behavior modification.

A further feature of the invention resides broadly in an improved toilet training aide and behavioral modification teaching and learning tool system to provide a means for facilitating the toilet training of children and behavior modification.

Another feature of the invention resides broadly in an improved toilet training aide and behavioral modification teaching and learning tool system to provide a method for promoting potty training and behavior modification.

Yet another feature of the invention resides broadly in an improved toilet training aide system to provide a method for reducing the volume of disposable diapers in landfills.

Still another feature of the invention resides broadly in an improved toilet training aide and behavioral modification teaching and learning tool system for selecting a reward type by the parent or care giver and child.

A further feature of the invention resides broadly in an improved toilet training aide and behavioral modification teaching and learning tool system rewarding the child with the previously chosen reward type with a successful toilet training or behavior modification experience (perhaps one pressure sensitive label for sitting, two pressure sensitive labels for urination and three pressure sensitive labels for defecation).

Another feature of the invention resides broadly in an improved toilet training aide and behavioral modification teaching and learning tool system of positive reinforcement with guidance for toilet training and behavior modification of children.

Yet another feature of the invention resides broadly in an improved toilet training aide and behavioral modification teaching and learning tool system of providing and displaying a design which comprises forming the design from a piece of sheet material showing a themed displaying background image.

Still another feature of the invention resides broadly in an improved toilet training aide and behavioral modification teaching and learning tool system wherein the pressure sensitive labels match appropriately in themes to form a set of approximately thirty on a sheet.

A further feature of the invention resides broadly in an improved toilet training aide and behavioral modification teaching and learning tool system wherein the pressure sensitive labels match appropriately in themes and when applied by the child may form an educational tool, a specific learning experience, a scene or picture.

Another feature of the invention resides broadly in an improved toilet training aide and behavioral modification teaching and learning tool system to stimulate a child's imagination.

Yet another feature of the invention resides broadly in an improved toilet training aide and behavioral modification teaching and learning tool system having pressure sensitive labels produced in various shapes, sizes, colors and themes.

Still another feature of the invention resides broadly in an improved toilet training aide and behavioral modification teaching and learning tool system to provide a toilet training aide and behavior modification for children.

A further feature of the invention resides broadly in an improved toilet training aide and behavioral modification teaching and learning tool system to provide a method for toilet training and behavior modification for children.

Another feature of the invention resides broadly in an improved toilet training aide and behavioral modification teaching and learning tool system to provide a portable toilet training aide and behavior modification aide.

Another feature of the invention resides broadly in an improved toilet training aide and behavioral modification teaching and learning tool system to provide a toilet training aide and behavioral modification tool that can go everywhere, everyday without inconvenience and taking up space.

Still another feature of the invention resides broadly in an improved toilet training aide and behavioral modification teaching and learning tool system to provide parents and care givers an avenue of keeping with consistency for the child with ease and without inconveniencing anyone.

A further feature of the invention resides broadly in an improved toilet training aide and behavioral modification teaching and learning tool system to provide busy parents and care givers an innovative way to entice children to toilet train and behavior modification at an earlier age.

Another feature of the invention resides broadly in an improved toilet training aide and behavioral modification teaching and learning tool system to provide ease and comfort on daily trips, vacations and long journeys without disrupting a child's training experience preventing setbacks due to inconsistent toilet training and behavior modification.

Yet another feature of the invention resides broadly in an improved toilet training aide and behavioral modification teaching and learning tool system that can also be used as any type of reward kit or discipline aide.

Still another feature of the invention resides broadly in an improved toilet training aide and behavioral modification teaching and learning tool system that is uncomplicated, not cumbersome or bulky, not take up too much space, a true unisex system, travels well daily as well as on vacations.

A further feature of the invention resides broadly in an improved toilet training aide and behavioral modification teaching and learning tool system providing the ability to be concise in the method of rewarding.

Another feature of the invention relates resides broadly in an improved toilet training aide and behavioral modification teaching and learning tool system providing a toilet training and behavior modification kit which is fun to play with for the children.

Yet another feature of the invention resides broadly in an improved toilet training aide and behavioral modification teaching and learning tool system for the teaching of a sibling or playmate in the use of the toilet training aide and behavior modification with success.

Still another feature of the invention resides broadly in an improved toilet training aide and behavioral modification teaching and learning tool system wherein the pressure sensitive labels match appropriately in themes and when applied by the child may be placed in any direction and be correct, due to artwork design and concept of what is being called stage one designs, to form a specific learning experience, scene or picture.

Yet another feature of the invention resides broadly in a behavioral modification teaching and learning tool system wherein the pressure sensitive labels match appropriately in themes and when applied by the child may be placed in various positions and be correct, due to artwork design and concept of what is being called stage two designs, to form a specific learning experience, scene or picture.

A further feature of the invention resides broadly in an improved toilet training aide and behavioral modification teaching and learning tool system that may be embodied in various forms.

The sticker sets are an improved and portable toilet training aide and behavioral modification teaching and learning tool system. They come in many themes. Each theme allows children creativity and imagination development while reinforcing a positive and rewarding system for toilet training and behavior modification. The sticker sets are colorful pressure sensitive labels which children place onto a preprinted background of various themes. Each individual theme set has a theme background design which is imprinted onto a surface such as, but not limited to, paper and has a variety of approximately thirty colorful theme related designs imprinted onto a surface such as, but not limited to, a pressure sensitive label stock and custom die cut on a second sheet.

Each set of stickers belongs to its own individual theme background sheet to apply each of the stickers onto, thus creating an interesting scene, picture, or educational topic. The child selects a sticker for a successful potty or behavior modification experience and then places it anywhere he or she desires on the preprinted background sheet. For more encouragement in the beginning of toilet training and behavior modification a child can be given one sticker for trying any of the desired tasks they are expected to perform.

In our fast-paced world, single-parent households, multi-children households, all parents and care givers, and child care systems will benefit and have a portable, consistent reinforcement system during toilet training and behavior modification that is a positive imagination developmental tool creating self esteem in the child and developing skills. The sticker sets travel well, they are portable, uncomplicated, not bulky or cumbersome, truly unisex, educational and creative toilet training aids and behavioral modification teaching and learning tool systems.

The components disclosed in the various publications, disclosed or incorporated by reference herein, may be used in the embodiments of the present invention, as well as equivalents thereof.

The appended drawings in their entirety, including all dimensions, proportions and/or shapes in at least one embodiment of the invention, are accurate and are hereby included by reference into this specification.

All, or substantially all, of the components and methods of the various embodiments may be used with at least one embodiment or all of the embodiments, if more than one embodiment is described herein.

All of the patents, patent applications and publications recited herein, and in the Declaration attached hereto, are hereby incorporated by reference as if set forth in their entirety herein.

All of the references and documents, cited in any of the documents cited herein, are hereby incorporated by reference as if set forth in their entirety herein. All of the documents cited herein, referred to in the immediately preceding sentence, include all of the patents, patent applications and publications cited anywhere in the present application.

The details in the patents, patent applications and publications may be considered to be incorporable, at applicant's option, into the claims during prosecution as further limitations in the claims to patentably distinguish any amended claims from any applied prior art.

Some examples of toilet training devices, methods, and designs for toilet training devices, which could possibly be utilized or adapted for use in at least one possible embodiment of the present invention, may possibly be found in the following U.S. patents: U.S. Pat. No. D455,662, entitled “Toilet training timepiece;” No. 6,250,929, entitled “Methods for improving the effectiveness of toilet training;” No. 6,203,327, entitled “Toilet training system;” No. D428,976, entitled “Toilet training target;” No. 6,052,840, entitled “Toilet training accessory;” No. 6,033,229, entitled “Medical device for toilet training young children;” No. D420,110, entitled “Portable child's toilet training device;” No. 5,978,976, entitled “Potty for toilet training;” No. 5,829,073, entitled “Toilet training kit;” No. 5,817,076, entitled “Toilet training diapers;” No. 5,797,892, entitled “Toilet training aid providing a dimensional change;” No. 5,734,998, entitled “Toilet training device;” No. 5,725,382, entitled “Self-contained, interactive toilet training kit for children and caregivers;” No. 5,702,377, entitled “Wet liner for child toilet training aid;” No. 5,702,376, entitled “Toilet training aid providing a temperature and dimensional change sensation;” No. D388,160, entitled “Toilet training device;” No. 5,690,495, entitled “Incentive device for toilet training children;” No. D386,571, entitled “Toilet training step;” No. 5,681,298, entitled “Toilet training aid creating a temperature change;” No. 5,649,914, entitled “Toilet training aid;” No. 5,573,407, entitled “Toilet training apparatus and method;” No. 5,560,051, entitled “Toilet training device;” No. 5,537,695, entitled “Musical toilet training device;” No. 5,509,808, entitled “Toy toilet training kit;” No. 5,369,820, entitled “Toilet training potty;” No. 5,363,516, entitled “Toilet training device for children;” No. 5,353,449, entitled “Toilet training method;” No. D350,819, entitled “Toilet training seat for infants;” No. D345,202, entitled “Toilet training unit for a child;” No. 5,285,540, entitled “Toilet training system;” No. D341,853, entitled “Wall mounted display board for children's toilet training;” No. D341,650, entitled “Toilet training set for children;” No. D330,225, entitled “Wall mounted display board for children's toilet training;” No. 5,117,515, entitled “Toilet training device and method of use;” No. D324,906, entitled “Toilet training seat for children;” No. 5,038,703, entitled “Device and method to aid in toilet training pets;” No. D316,278, entitled “Wall mounted display board for children's toilet training;” No. D311,058, entitled “Toilet training chair for children;” No. D310,869, entitled “Toilet training seat for children;” No. 4,944,733, entitled “Diaper for use in toilet training male children or for use by incontinent male adults;” No. D308,989, entitled “Wall mounted display board for children's toilet training;” No. 4,909,804, entitled “Child's toilet training pants;” No. 4,883,749, entitled “Children's toilet training device with differentiating means;” No. 4,744,113, entitled “Toilet training aid and method;” No. D276,361, entitled “Children's toilet training chair;” No. 4,443,200, entitled “Toilet training device;” No. D258,679, entitled “Child toilet training center;” No. 4,205,404, entitled “Toilet training device;” and No. 4,162,490, entitled “Toilet training device.”

Some examples of potties, potty training devices, methods, and designs for potties, which could possibly be utilized or adapted for use in at least one possible embodiment of the present invention, may possibly be found in the following U.S. patents: U.S. Pat. No. D454,624, entitled “Potty with stepstool;” No. 6,353,941, entitled “Starling potty;” No. 6,341,386, entitled “Portable potty apparatus;” No. D453,040, entitled “Decorative potty chair;” No. D444,551, entitled “Potty training lid cover;” No. 6,115,855, entitled “Disposable biodegradable potty liner;” No. 6,112,339, entitled “Portable toddler/young child potty;” No. D423,654, entitled “Potty chair;” No. 6,038,711, entitled “Potty training device;” No. 5,991,938, entitled “Potty trainer and desk combination;” No. 5,978,976, entitled “Potty for toilet training;” No. 5,937,795, entitled “Pets disposable potty;” No. 5,926,864, entitled “Musical potty chair;” No. D410,739, entitled “Children's portable potty;” No. 5,893,178, entitled “Musical potty trainer;” No. 5,890,242, entitled “Electronic potty trainer with audible rewarding system and visually amusing target;” No. D402,739, entitled “Disposable potty liner;” No. 5,809,584, entitled “Travel potty apparatus;” No. 5,781,939, entitled “Potty training chair with child restraint, activity area and audible reward system;” No. 5,753,331, entitled “Potty training toilet tissue;” No. 5,685,029, entitled “Potty training device;” No. D385,302, entitled “Combined watch pin and card holder potty training unit;” No. 5,652,975, entitled “Automatic talking potty apparatus;” No. D381,070, entitled “Disposable potty chair liner;” No. D377,452, entitled “Child's timing device for monitoring potty time;” No. D376,923, entitled “Potty step;” No. 5,535,456, entitled “Potty;” No. 5,518,405, entitled “Musical potty training device;” No. D368,517, entitled “Child's potty chair;” No. D365,693, entitled “Potty step;” No. D361,625, entitled “Potty;” No. 5,432,956, entitled “Potty seat with liquid-filled chamber;” No. D354,342, entitled “Disposable potty liner;” No. 5,369,820, entitled “Toilet training potty;” No. 5,365,496, entitled “Potty trainer timepiece;” No. 5,103,772, entitled “Pet potty;” No. 5,040,248, entitled “Stand-up training potty for male toddlers;” No. 4,979,469, entitled “Portable pet potty and wetting wall;” No. 4,892,058, entitled “Portable pet potty and wetting wall;” No. 4,777,680, entitled “Musical potty chair;” No. D297,258, entitled “Infant potty seat;” No. 4,633,536, entitled “Collapsible potty chair with disposable bag;” No. 4,509,215, entitled “Disposable liner for a musical potty chair;” and No. 4,381,568, entitled “Combination potty seat and step stool.”

The invention as described hereinabove in the context of the preferred embodiments is not to be taken as limited to all of the provided details thereof, since modifications and variations thereof may be made without departing from the spirit and scope of the invention.

What is claimed is:

1. A method of toilet training a child using a portable toilet training kit, said kit comprising a background sheet having a design printed thereon and a plurality of stickers; each of said plurality of stickers comprising an image, which image corresponds to said background sheet design; and each of said plurality of stickers being configured to be affixed to said background sheet by a child, said method comprising the steps of:
placing said background sheet adjacent a toilet of a child;
determining a first number of said plurality of stickers to be given to the child upon the child completing a first task in the use of said toilet, said first task comprising sitting on said toilet;
determining a second number of said plurality of stickers, said second number being greater than said first number, to be given to the child upon the child completing a second task in the use of said toilet, said second task comprising urinating in said toilet; and
determining a third number of said plurality of stickers, said third number being greater than said second number, to be given to the child upon the child completing a third task in the use of said toilet, said third task comprising defecating in said toilet;
the child completing at least one of said first task, said second task, and said third task;
awarding the child at least one of the first number of stickers, the second number of stickers, and the third number of stickers in accordance with the at least one completed task;
the child choosing each of said awarded number of stickers from said plurality of stickers;
permitting the child to place each of said awarded number of stickers on said background sheet to create a decorative scene;
the child affixing each of said awarded number of stickers to said background sheet to create a decorative scene;
the child completing at least another of said first task, said second task, and said third task;
awarding the child at least one of the first number of stickers, the second number of stickers, and the third number of stickers in accordance with the at least another completed task;
the child choosing each of said awarded number of stickers from said plurality of stickers;
permitting the child to place each of said awarded number of stickers on said background sheet to create a decorative scene;
the child affixing each of said awarded number of stickers to said background sheet to create a decorative scene; and
repeating the above steps until the child sufficiently masters all of said first task, said second task, and said third task to complete training in use of the toilet.

2. A method of behavior modification of a child using a portable kit, said kit comprising a background sheet having a design printed thereon and a plurality of stickers; each of said plurality of stickers comprising an image, which image corresponds to said background sheet design; and each of said plurality of stickers being configured to be affixed to said background sheet by a child, said method comprising the steps of:
determining a plurality of desired tasks to be completed by the child;
ranking said desired tasks in order of degree of difficulty from easy to hard;
determining a number of said plurality of stickers to be given to the child upon the child completing a desired task for each of said plurality of desired tasks;
the child completing at least one of said plurality of desired tasks;
awarding the child a number of stickers in accordance with the at least one completed task;
the child choosing each of said awarded number of stickers from said plurality of stickers;
permitting the child to place each of said awarded number of stickers on said background sheet to create a decorative scene;
the child affixing each of said awarded number of stickers to said background sheet to create a decorative scene;
the child completing at least another of said plurality of desired tasks;
awarding the child another number of stickers in accordance with the at least another completed task;
the child choosing each of said awarded number of stickers from said plurality of stickers;
permitting the child to place each of said awarded number of stickers on said background sheet to create a decorative scene;
the child affixing each of said awarded number of stickers to said background sheet to create a decorative scene; and
repeating the above steps until the child sufficiently masters all of said plurality of desired tasks.

3. A toilet training kit for training children how to use the toilet, said toilet training kit comprising:
a background sheet having a design printed thereon;
a plurality of labels, each comprising an image, which image corresponds to said background sheet design; and
each of said plurality of labels being configured to be affixed to said background sheet by a child.

4. The toilet training kit according to claim 3, wherein:
said plurality of labels comprise a plurality of stickers;
each of said stickers has a first side and a second side opposite said first side;
said image is disposed on said first side of each of said stickers; and
each of said stickers comprise an adhesive disposed on said second side to permit attachment of each of said stickers to said background sheet.

5. The toilet training kit according to claim 4, wherein:
said background sheet has length and width dimensions of one of:
eight and a half inches by eleven inches;
eight and a half inches by fourteen inches; and
eleven inches by seventeen inches.

6. The toilet training kit according to claim 5, wherein:
said background sheet comprises a front surface and a back surface disposed opposite said front surface;
said design of said background sheet comprises a printed design disposed on said front surface of said background sheet;
said printed design is configured to cover one of:
all of said front surface; and
a portion of said front surface.
